(19) United States
(12) Patent Application Publication
(10) Pub. No.: US 2025/0371460 A1
(43) Pub. Date: Dec. 4, 2025

(54) DYNAMICALLY GENERATING AND UPDATING AN ALLOCATION OF TRANSPORTATION PROVIDERS ACROSS GEOCODED AREAS

(71) Applicant: Lyft, Inc., San Francisco, CA (US)

(72) Inventors: Hao Yi Ong, San Francisco, CA (US); Eduardo Lourenco Apolinario, Kirkland, WA (US); Davide Crapis, Berkeley, CA (US); Matthew Lawrence Green, San Francisco, CA (US)

(21) Appl. No.: 19/296,619

(22) Filed: Aug. 11, 2025

Related U.S. Application Data
(63) Continuation of application No. 16/539,965, filed on Aug. 13, 2019.

(51) Int. Cl. G06Q 10/0631; G06Q 10/02; G06Q 10/04; G06Q 50/40; G08G 1/00

(52) U.S. Cl. CPC G06Q 10/06312; G06Q 10/02; G06Q 10/04; G06Q 50/40; G08G 1/20

(57) ABSTRACT

This disclosure describes methods, non-transitory computer readable media, and systems that can iteratively adjust an allocation of transportation providers across geocoded areas for a time period until identifying a final allocation of transportation providers corresponding to an improved transportation-value metric for the geocoded areas. By iteratively adjusting both a transportation-value metric and a transportation-provider allocation across geocoded areas, the disclosed systems intelligently generate a final allocation of transportation providers that increases a transportation efficiency reflected in the transportation-value metric. The disclosed systems' iterative approach to adjusting a transportation-provider allocation across geocoded areas can improve the efficiency and flexibility of transportation-network systems in allocating transportation providers and can integrate constraints for provider allocations, neighboring geocoded areas, provider inducements, and projected transportation requests within a unified computational model.

### CROSS-REFERENCE TO RELATED APPLICATIONS

The present application is a continuation of U.S. application Ser. No. 16/539,965, filed on Aug. 13, 2019. The aforementioned application is hereby incorporated by reference in its entirety.

### BACKGROUND

Transportation-network systems commonly use web and mobile applications to manage on-demand requests for transportation. Some on-demand transportation-network systems, for example, receive requests from persons through a mobile application requesting transportation from one geographic area to another geographic area. To fulfill such requests, on-demand transportation-network systems traditionally use a computational model that matches requests from persons seeking transportation with nearby transportation providers, such as autonomous vehicles or drivers of transportation vehicles. By efficiently matching requests with nearby transportation providers, on-demand transportation-network systems can use a computational model to incentivize transportation providers to travel to high-volume-request areas and to reduce estimated arrival times of transportation providers to a requestor's pickup location.

Some conventional on-demand transportation-network systems use static computational models to match requests with nearby transportation providers. Static computational models often cannot efficiently match requests with providers during volatile or high-volume time periods of requests. In other words, static computational models lack the ability to adjust the computational logic that matches transportation providers with requestors—while managing inducements for providers for target areas and maintaining reasonable estimated times of arrival—when requests reach high volumes or rapidly vary in volume over one or more time periods.

In addition to allocation inefficiencies, some conventional transportation-network systems use separate computational models to account for inducements for transportation providers and for matching requests with nearby transportation providers. By employing separate computational models, existing transportation-network systems can decrease the accuracy of providing marginal incentives to transportation providers to travel to target areas. Without accounting for expenditures in incentivizing transportation providers to move to such areas and volume limits for fielding requests, some conventional transportation-network systems decrease the rate at which people request transportation and the rate at which transportation providers accept such requests.

Accordingly, conventional on-demand transportation-network systems may create problems for both people requesting transportation and transportation providers with static or isolated computational models. For example, conventional on-demand transportation-network systems may rigidly (and too quickly) provide inducements for transportation providers to pick up requestors based on a static computational model—without accounting for factors affecting a successful match of requestors and providers and the variability of provider inducements to travel to target areas. By employing static or isolated computational models, on-demand transportation-network systems may also rigidly distribute inducements to provider client devices without accounting for the rate of matching requestors with transportation providers.

### SUMMARY

This disclosure describes one or more embodiments of methods, non-transitory computer readable media, and systems that solve the foregoing problems in addition to providing other benefits. In particular, the disclosed systems can iteratively adjust an allocation of transportation providers across geocoded areas for a time period until identifying a final allocation of transportation providers corresponding to an improved transportation-value metric for the geocoded areas. By iteratively adjusting both a transportation-value metric and a transportation-provider allocation across geocoded areas, the disclosed systems intelligently generate a final allocation of transportation providers that increases a transportation efficiency reflected in the transportation-value metric. The disclosed systems' iterative approach to adjusting a transportation-provider allocation across geocoded areas can improve the efficiency and flexibility of transportation-network systems in allocating transportation providers and can integrate constraints for provider allocations, neighboring geocoded areas, provider inducements, and projected transportation requests within a unified computational model.

In some embodiments, for instance, the disclosed systems generate a transportation-value metric corresponding to geocoded areas for a time period based on a projected allocation of transportation providers. Until reaching an iteration threshold, the disclosed systems iteratively adjust an allocation of transportation providers across the geocoded areas for the time period and generate an updated transportation-value metric based on the adjusted allocation of transportation providers. Based on reaching the iteration threshold, the disclosed systems identify a final adjusted allocation of transportation providers corresponding to the geocoded areas for the time period. The disclosed systems then distribute instructions associated with the final adjusted allocation of transportation providers to transportation providers devices associated with corresponding transportation providers.

### BRIEF DESCRIPTION OF THE DRAWINGS

The detailed description refers to the drawings briefly described below.

FIG. 1 illustrates a block diagram of an environment for implementing a transportation matching system in accordance with one or more embodiments.

FIG. 2 illustrates a sequence-flow diagram of a transportation matching system iteratively adjusting a transportation-provider allocation across geocoded areas and a transportation-value metric until reaching an iteration threshold in accordance with one or more embodiments.

FIG. 3 illustrates a transportation matching system using a transportation-rate model and a provider-allocation model to iteratively adjust a transportation-provider allocation across geocoded areas and a transportation-value metric subject to constraints until reaching an iteration threshold in accordance with one or more embodiments.

FIGS. 4A-4B illustrate an initial allocation of transportation providers across geocoded areas and a final allocation of transportation providers across the geocoded areas in accordance with one or more embodiments.

FIGS. 5A-5C illustrate a provider client device presenting graphical user interfaces notifying a provider of (or identifying) a provider-rate inducement for target geocoded areas in accordance with one or more embodiments.

FIGS. 6A-6B illustrate a comparison of conversion rates within a region of geocoded areas based on transportation-provider allocations from a static transportation-network system and from a transportation matching system in accordance with one or more embodiments.

FIG. 7 illustrates graphs demonstrating improved conversion rates across geocoded areas for samples processed by different embodiments of a transportation matching system in accordance with one or more embodiments.

FIG. 8 illustrates a flowchart of a series of acts for iteratively adjusting an allocation of transportation providers across geocoded areas for a time period until identifying a final allocation of transportation providers corresponding to an improved transportation-value metric corresponding to the geocoded areas in accordance with one or more embodiments.

FIG. 9 illustrates a block diagram of a computing device in accordance with one or more embodiments.

FIG. 10 illustrates an example environment for a transportation matching system in accordance with one or more embodiments.

### DETAILED DESCRIPTION

This disclosure describes one or more embodiments of a transportation matching system that iteratively adjusts an allocation of transportation providers across geocoded areas for a time period until identifying a final allocation of transportation providers corresponding to an improved transportation-value metric corresponding to the geocoded areas. By iteratively adjusting both a transportation-value metric and a transportation-provider allocation across geocoded areas, the transportation matching system intelligently generates a final allocation of transportation providers that increases a transportation efficiency reflected in the transportation-value metric. In some cases, the transportation matching system adjusts such transportation-provider allocations subject to constraints for allocations of transportation providers, neighboring geocoded areas, provider inducements, and projected transportation requests. The transportation matching system's iterative approach to adjusting an allocation of transportation providers across geocoded areas can improve the efficiency and flexibility of transportation-network systems in allocating transportation providers and can integrate a combination of the foregoing or other constraints within a unified computational model.

In some embodiments, for instance, the transportation matching system generates a transportation-value metric corresponding to geocoded areas for a time period based on a projected allocation of transportation providers. Until reaching an iteration threshold, the transportation matching system iteratively adjusts an allocation of transportation providers across the geocoded areas for the time period and generates an updated transportation-value metric based on the adjusted allocation of transportation providers. Based on reaching the iteration threshold, the transportation matching system identifies a final adjusted allocation of transportation providers corresponding to the geocoded areas for the time period. The transportation matching system then distributes instructions associated with the final adjusted allocation of transportation providers to transportation providers devices associated with corresponding transportation providers.

To generate the transportation-value metric for a given iteration, the transportation matching system may generate various transportation-value metrics, including a booking metric, a conversion metric, a profit metric, or a revenue metric. In some embodiments, the transportation matching system determines an initial transportation-value metric based on both a projected number of transportation requests and (as noted above) a projected allocation of transportation providers across geocoded areas. In subsequent iterations, the transportation matching system further generates updated transportation-value metrics based on an adjusted projected number of transportation requests and an adjusted projected allocation of transportation providers across the geocoded areas. In each iteration, a transportation-value metric can accordingly account for or reflect a projected (and iteratively adjusted) number of transportation requests and allocation of transportation providers.

When adjusting such an allocation of transportation providers, the transportation matching system can generate an allocation-flow matrix indicating transportation providers traveling from initial geocoded areas to target geocoded areas. The transportation matching system can use such an allocation-flow matrix as a basis for generating an adjusted allocation of transportation providers. For example, in certain implementations, the transportation matching system applies (i) a probability of transportation providers traveling from the initial geocoded areas to the target geocoded areas to (ii) an allocation-flow matrix as a basis for generating an adjusted allocation of transportation providers for a given iteration.

As further suggested above, the transportation matching system can also generate transportation-value metrics and adjust transportation-provider allocations subject to constraints for allocations of transportation providers, neighboring geocoded areas, provider inducements, and projected transportation requests. For example, the transportation matching system can generate an adjusted allocation of transportation providers to comply with (i) a neighborhood constraint comparing requests and available transportation providers within a geocoded neighborhood or (ii) a provider-target constraint comprising limits for expenditures per incremental transportation service for a time period. Additionally, or alternatively, an adjusted allocation may account for (iii) a treatment constraint reflecting limits for numbers of projected transportation requests for the time period or (iv) an allocation constraint comprising limits on values for an allocation-flow matrix.

To iterate through transportation-value metrics and transportation-provider allocations, in certain implementations, the transportation matching system uses both a transportation-rate model and a provider-allocation model. In a given iteration, for example, the transportation matching system uses a transportation-rate model to generate a transportation-value metric corresponding to geocoded areas for a time period. As part of the iteration, the transportation matching system uses a provider-allocation model to generate a corresponding allocation of transportation providers across geocoded areas for the time period based on the transportation-value metric.

Regardless of the system's structure or constituent models, the transportation matching system can continue to adjust transportation-value metrics and transportation-provider allocations until reaching an iteration threshold. For instance, the transportation matching system can satisfy an iteration threshold by reaching a transportation-value-metric convergence or reaching a time threshold, whichever occurs sooner. In some cases, the transportation matching system can identify a transportation-value-metric convergence by determining that updated transportation-value metrics have not increased in value after or upon processing a threshold number of iterations. By contrast, the transportation matching system can identify a time threshold by determining a threshold amount of time has elapsed since initializing transportation-provider or transportation-request projections for a time period. Upon reaching an iteration threshold, the transportation matching system identifies a final adjusted allocation of transportation providers upon which the system generates a convergent transportation-value metric.

After identifying a final adjusted allocation of transportation providers, the transportation matching system distributes instructions to provider client devices based on the final adjusted allocation. In some cases, for instance, the transportation matching system transmits sets of instructions to provider client devices associated with autonomous vehicles to travel to one or more target geocoded areas. Additionally, or alternatively, the transportation matching system provides provider client devices a graphical user interface identifying one or more transportation-rate inducements for one or more target geocoded areas.

As suggested above, the transportation matching system improves and overcomes several technical deficiencies that hinder conventional transportation-network systems. For instance, the transportation matching system improves the accuracy and efficiency with which a transportation-network system allocates transportation providers across geocoded areas. By implementing a static or isolated computational model, existing transportation-network systems fail to account for inducements for transportation providers and the impact of such inducements on matching requests with transportation providers in geocoded areas. In contrast, the transportation matching system accounts for such inducements by iteratively adjusting both a transportation-value metric and a transportation-provider allocation across geocoded areas until identifying a final allocation of transportation providers. Such a final transportation-provider allocation more accurately matches projected transportation requests with transportation providers as measured by a convergent transportation-value metric or a time threshold. Whether represented in terms of bookings, conversion, profit, or revenue, the transportation matching system can increment transportation-provider allocations throughout geocoded areas until identifying an allocation that reflects efficiency on the ground as measured by the transportation-value metric.

In addition to improved accuracy and efficiency, the transportation matching system also improves the flexibility of existing transportation-network systems by integrating a transportation-value metric, transportation-provider allocations, or other transportation factors into a unified computational model. Rather than isolate computational models from other transportation factors as in conventional systems, the transportation matching system improves the flexibility of transportation-provider allocations by iteratively determining how different transportation-provider allocations affect a transportation-value metric. In quick succession, the transportation matching system can iterate through different transportation-provider allocations throughout geocoded areas to match projected transportation requests. Beyond balancing allocations and corresponding transportation-value metrics for a time period, in some embodiments, the transportation matching system further improves the flexibility of transportation-provider allocations by iteratively accounting for input constraints for neighboring geocoded areas, provider inducements, and projected transportation requests in a unified computational model.

As indicated by the foregoing description, this disclosure uses a variety of terms to describe features and advantages of a transportation matching system. As used in this disclosure, the term “transportation-value metric” refers to a measurement of efficiency or value for a geocoded area or multiple geocoded areas. For example, in some embodiments, a transportation-value metric refers to (i) a booking metric indicating a quantity of transportation requests projected for receipt from requestors or acceptance by providers in a time period, (ii) a conversion metric indicating a projected quantity or projected rate at which transportation requests result in completed transportation services across geocoded areas in a time period, (iii) a profit metric indicating a projected monetary profit for matching transportation requests to transportation providers across geocoded areas in a time period, or (iv) a revenue metric indicating a projected quantity of revenue for matching transportation requests to transportation providers across geocoded areas in a time period.

As suggested above, the transportation matching system sometimes reaches a transportation-value-metric convergence or a time threshold after multiple iterations. The term “transportation-value-metric convergence” refers to a point of convergence for transportation-value metrics generated in multiple iterations. In some embodiments, for example, a transportation-value-metric convergence refers to a threshold number of iterations at which transportation-value metrics have not increased in value or have not increased in value more than (or equal to) a threshold variance. The term “time threshold” refers to a threshold amount (or maximum amount) of time elapsed since initiating projections for a time period or since another initialization reference point. For examples, in some cases, a time threshold refers to a threshold amount of time since initially generating a projected number of transportation requests for a time period, initially generating a projected allocation of transportation providers for the time period, or initially generating a transportation-value metric for the time period.

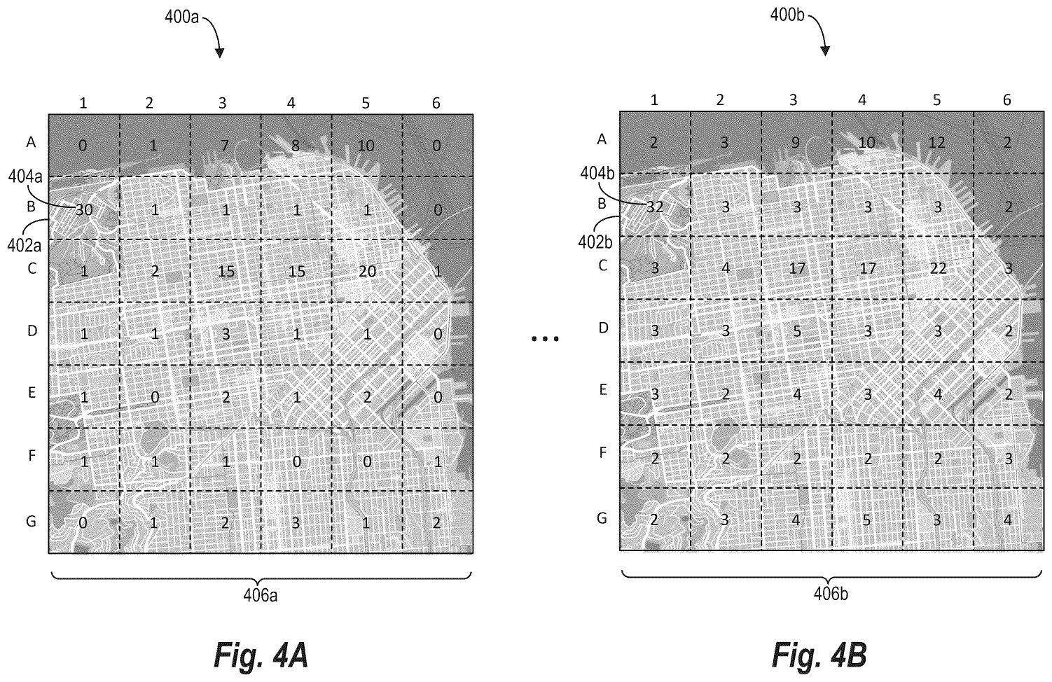

As further suggested above, the term “allocation of transportation providers” (or “transportation-provider allocation”) refer to a distribution of transportation providers within a geocoded area or across geocoded areas. For example, an allocation of transportation providers may refer to a quantity of available transportation providers within an individual geocoded area or within each geocoded area from among multiple geocoded areas for a time period. In some embodiments, an allocation of transportation providers is represented within an allocation matrix indicating quantities of available transportation providers for each geocoded area within a region. As described below, FIGS. 4A and 4B depict examples of an allocation of transportation providers represented as an allocation matrix.

By contrast, the term “allocation-flow matrix” refers to a matrix indicating transportation providers traveling from initial geocoded areas to target geocoded areas. In some embodiments, for example, an allocation-flow matrix refers to values arranged in rows and columns, where each value indicates a change in transportation providers for a particular geocoded area moving to or from one or more target geocoded areas. In some such embodiments, an allocation-flow matrix includes fractions or percentages to indicate a change in transportation providers for a geocoded area.

Relatedly, the term “geocoded region” (or simply “region”) refers to a spatial division or unit of a larger geographic space. For instance, in some embodiments, a region refers to a city, a collection of cities, or a portion of a city. Such regions may include, for example, Chinatown of San Francisco, California; San Francisco, California; or one or more of the Boroughs of New York City, New York. As described below, a region includes a collection of geocoded areas.

The term “geocoded area” refers to a spatial subdivision or subunit of a region or a larger geographic space. A geocoded area may be a subdivision of a geographic neighborhood as well as a subdivision of a city. As a subdivision, a geocoded area may include a segment of a street, a street, a set of bordering streets, a city block, a set of city blocks, or another portion of an area within a larger geographic space. For example, a set of bordering streets may define a geocoded area within a larger space, such as a set of streets around Times Square in New York City, New York. In certain embodiments, a geocoded area represents a geographic hash (“geohash”) in a grid (or other polygon shape) of geohashes within a larger geographic space. Regardless of the form of a geocoded area, one or more requestors or providers may be located within a geocoded area.

A geocoded area may be part of or adjacent to a geographic neighborhood. The term “geographic neighborhood” (or simply “neighborhood”) refers to a geographic region that includes multiple geographic areas, but that is smaller than a region. In particular, each area can be the focus of a neighborhood, and adjacent areas can have overlapping neighborhoods. For example, a neighborhood includes areas adjacent to a given area (e.g., immediately surrounding the given area), areas within a threshold distance or radius of the given area, and/or areas that are within a threshold travel time (e.g., driving distance) of the given area. In some embodiments, a neighborhood includes geocoded areas to which a transportation provider can travel within a threshold expiration time given the transportation provider's original or current location.

Further, the term “time period” refers to an interval of time determined or set by a transportation matching system. A time period may be any time interval, including, but not limited to, a one-minute interval or a one-hour interval. For example, a time period may be a one-minute interval from 2:15 p.m. to 2:16 p.m. on Thursday, Jun. 18, 2020. As another example, a time period may be a five-minute interval from 5:00 p.m. to 5:15 p.m. on Sunday, Jun. 21, 2020. In some embodiments, for example, the transportation matching system sets a time period for which to collect or project data, such as location information, price estimates, estimated times of arrival, number of available transportation vehicles, number of projected transportation requests, and other relevant data. In some such embodiments, the transportation matching system collects and organizes the data by time period and geographic area and/or geographic neighborhood.

As suggested above, the term “transportation provider” (or simply “provider”) refers to a driver or other person who operates a transportation vehicle and/or who interacts with a provider client device, on the one hand, or an autonomous vehicle, on the other hand. For instance, a transportation provider includes a person who drives a transportation vehicle along various routes—or an autonomous vehicle that drives along such routes—to pick up and drop off requestors of transportation. Accordingly, an allocation of transportation providers may include an allocation of one or both of human providers driving transportation vehicles and autonomous vehicles across geocoded areas.

Relatedly, the term “provider client device” refers to a computing device associated with (or used by) a provider or a transportation vehicle. In some embodiments, a provider client device includes a provider client application comprising instructions that (upon execution) cause the provider client device to perform various actions for a transportation matching system, as described herein. Such instructions may likewise cause a provider client device to present a graphical user interface identifying one or more transportation-rate inducements for one or more target geocoded areas (e.g., within a heatmap).

By contrast, the term “transportation requestor” (or simply “requestor”) refers to person who requests or is projected to request a ride or other form of transportation from a transportation matching system. A requestor may refer to a person who requests a ride or other form of transportation but who is still waiting for pickup. A requestor may also refer to a person whom a transportation vehicle has picked up and who is currently riding within the transportation vehicle to a destination (e.g., a destination indicated by a requestor). Relatedly, the term “requestor client device” refers to a computing device associated with (or used by) a requestor. In some embodiments, a requestor client device includes a requestor client application comprising instructions that (upon execution) cause the requestor client device to perform various actions for a transportation matching system, as described herein.

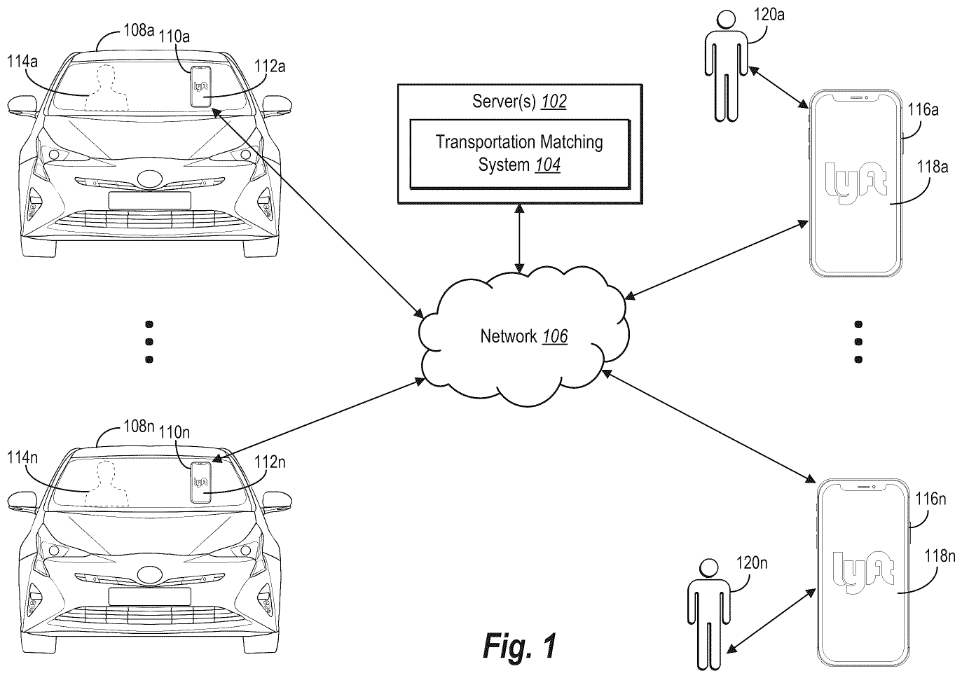

Turning now to the figures, FIG. 1 illustrates a schematic diagram of an environment 100 for implementing a transportation matching system 104 in accordance with one or more embodiments. As shown in FIG. 1, the environment 100 includes server(s) 102 comprising the transportation matching system 104, transportation vehicles 108a-108n, provider client devices 110a-110n respectively corresponding to the transportation vehicles 108a-108n, requestor client devices 116a-116n respectively corresponding to projected requestors 120a-120n, and a network 106. In some embodiments, the transportation vehicles 108a-108n optionally include one or both of providers 114a-114n. The providers 114a-114n in this example are human providers associated with both the transportation vehicles 108a-108n and the provider client devices 110a-110n, respectively.

The transportation matching system 104 uses the server(s) 102 to communicate with one or both of the provider client devices 110a-110n and the requestor client devices 116a-116n via the network 106. For example, the transportation matching system 104 communicates with the provider client devices 110a-110n and the requestor client devices 116a-116n via the network 106 to determine locations of the provider client devices 110a-110n and the requestor client devices 116a-116n, respectively. Per device settings, for instance, the transportation matching system 104 may receive location coordinates from the provider client devices 110a-110n and/or the requestor client device 116a-118n, respectively. Based on the location coordinates, the transportation matching system 104 matches or assigns one or more of the transportation vehicles 108a-108n with one or more of the projected requestors 120a-120n for transportation.

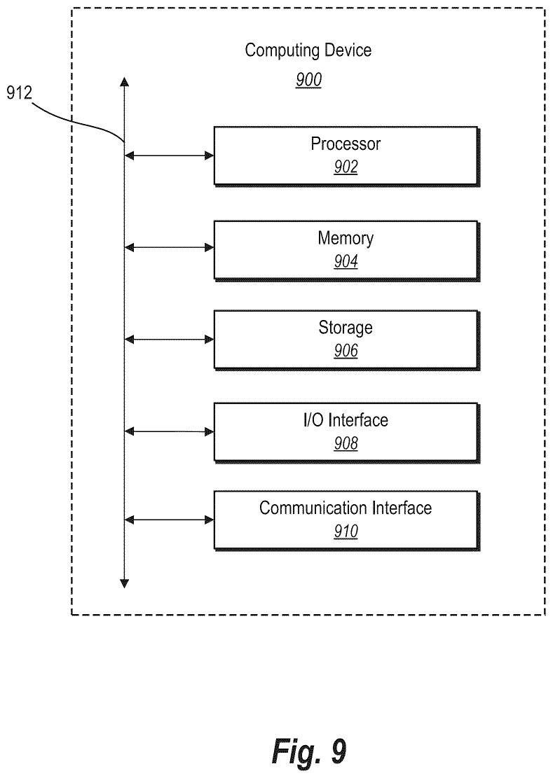

As suggested above, each of the provider client devices 110a-110n and the requestor client devices 116a-116n may comprise a mobile device, such as a laptop, smartphone, or tablet associated with a projected requestor or a provider. The provider client devices 110a-110n or the requestor client devices 116a-116n may be any type of computing device as further explained below with reference to FIG. 9. In some embodiments, one or more of the provider client devices 110a-110n are not associated with providers, but are attached to (or integrated within) the transportation vehicles 108a-108n, respectively.

As further indicated by FIG. 1, the provider client devices 110a-110n include provider client applications 112a-112n, respectively. Similarly, the requestor client devices 116a-116n include requestor client applications 118a-118n, respectively. In some embodiments, the provider client applications 112a-112n (or the requestor client applications 118a-118n) comprise web browsers, applets, or other software applications (e.g., native applications) respectively available to the provider client devices 110a-110n or the requestor client devices 116a-116n. Additionally, in some instances, the transportation matching system 104 provides data including instructions that, when executed by the provider client devices 110a-110n or by the requestor client devices 116a-116n, respectively create or otherwise integrate one of the provider client applications 112a-112n or the requestor client applications 118a-118n within an application or webpage.

As indicated by FIG. 1, a projected requestor may use a requestor client application to request transportation services, receive a price estimate for the transportation service, and access other transportation-related services. For example, the projected requestor 120a may interact with the requestor client device 116a through graphical user interfaces of the requestor client application 118a to enter a pickup location and a destination for transportation. The transportation matching system 104 can in turn provide the requestor client device 116a with a price estimate for the transportation and an estimated time of arrival of a transportation provider through the requestor client application 118a. Having received the price estimate, the projected requestor 120a may then select (and the requestor client device 116a detect) a selection of a transportation-request option to request transportation services from the transportation matching system 104.

As further depicted in FIG. 1, the transportation matching system 104 sends requests from one or more of the requestor client devices 116a-116n to one or more of the provider client devices 110a-110n within the transportation vehicles 108a-108n, respectively. While FIG. 1 depicts the transportation vehicles 108a-108n as automobiles, a transportation vehicle may also be an airplane, bicycle, motorcycle, scooter, or other vehicle. In some cases, this disclosure describes a transportation vehicle as performing certain functions, but such a transportation vehicle includes an associated provider client device that often performs a corresponding function. For example, when the transportation matching system 104 sends a transportation request to the transportation vehicle 108a—or queries location information from the transportation vehicle 108a—the transportation matching system 104 sends the transportation request or location query to the provider client device 110a. Accordingly, the transportation vehicle 108a and the provider client device 110a are part of a vehicle subsystem.

Although not illustrated in FIG. 1, in some embodiments, the environment 100 may have a different arrangement of components and/or may have a different number or set of components altogether. In certain implementations, for instance, some or all of the transportation vehicles 108a-108n do not include a human provider, but constitute autonomous transportation vehicles—that is, a self-driving vehicle that includes computer components and accompanying sensors for driving without manual-provider input from a human operator. As a further example, in some embodiments, one or more of the transportation vehicles 108a-108n include a hybrid self-driving vehicle with both self-driving functionality and some human operator interaction.

When a transportation vehicle is an autonomous vehicle or a hybrid self-driving vehicle, the transportation vehicle may include additional components not depicted in FIG. 1. Such components may include location components, one or more sensors by which the autonomous vehicle navigates, and/or other components necessary to navigate without a provider (or with minimal interactions with a provider). Regardless of whether a transportation vehicle is associated with a provider, a transportation vehicle optionally includes a locator device, such as a GPS device, that determines the location of the transportation vehicle within the transportation vehicles 108a-108n.

As mentioned above, the transportation vehicles 108a-108n respectively include provider client devices 110a-110n separate or integral to the transportation vehicles 108a-108n. Additionally, or alternatively, the provider client device 110a may be a subcomponent of a vehicle computing system. Regardless of its form, the provider client devices 110a-110n may include various sensors, such as a GPS locator, an inertial measurement unit, an accelerometer, a gyroscope, a magnetometer, and/or other sensors, from which the transportation matching system 104 can access information, such as location information.

In some embodiments, the transportation matching system 104 communicates with the provider client devices 110a-110n through the provider client applications 112a-112n, respectively. For instance, the provider client application 112a can cause the provider client device 110a to communicate with the transportation matching system 104 to navigate to a pickup location to pick up a requestor, navigate to a destination location, and/or collect fares. Further, in some cases, the provider client application 112a causes the provider client device 110a to communicate with the transportation matching system 104 to present a graphical user interface identifying one or more transportation-rate inducements for one or more target geocoded areas (e.g., within a heatmap).

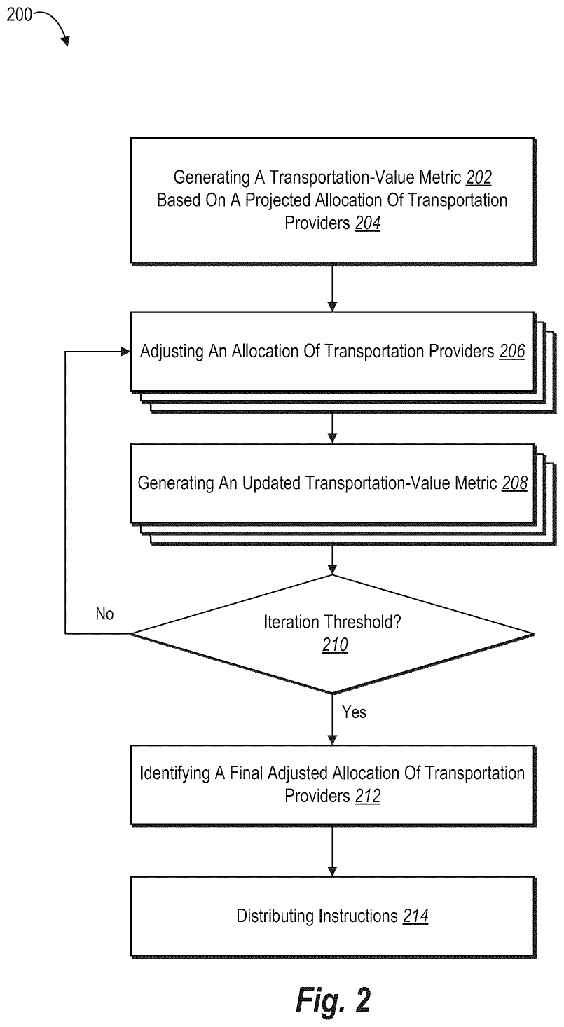

As suggested above, the transportation matching system 104 can iteratively adjust an allocation of transportation providers across geocoded areas. FIG. 2 illustrates a sequence-flow diagram 200 in which the transportation matching system 104 iteratively adjusts an allocation of transportation providers across (and a transportation-value metric corresponding to) geocoded areas for a time period until reaching an iteration threshold. Upon satisfying the iteration threshold, the transportation matching system 104 identifies a final allocation of transportation providers across the geocoded areas and distributes corresponding instructions to provider client devices.

As shown in FIG. 2, for example, the transportation matching system 104 generates a transportation-value metric 202 based on a projected allocation of transportation providers 204. The transportation-value metric 202 corresponds to geocoded areas within a geographic region for a time period. In some embodiments, the transportation matching system 104 generates the projected allocation of transportation providers 204 across the geocoded areas for the time period to initialize iterative adjustments. In addition to an initial provider-transportation allocation, in some cases, the transportation matching system 104 generates a projected number of transportation requests across the geocoded areas for the time period. Accordingly, the transportation matching system 104 can generate the transportation-value metric 202 based on both the projected allocation of transportation providers 204 and the projected number of transportation requests across the geocoded areas for the time period.

As further indicated by FIG. 2, the transportation matching system 104 uses the transportation-value metric 202 in an iterative process. Based on the transportation-value metric 202, the transportation matching system 104 adjusts an allocation of transportation providers 206 across the geocoded areas for the time period. The transportation matching system 104 further generates an updated transportation-value metric 208 for the time period based on the adjusted allocation of transportation providers. In some cases, the transportation matching system also adjusts a number of projected transportation requests across the geocoded areas for the time period. Accordingly, the transportation matching system 104 can generate the updated transportation-value metric 208 based on both the adjusted allocation of transportation providers and the adjusted number of projected transportation requests across the geocoded areas.

After generating the updated transportation-value metric 208, the transportation matching system 104 determines whether the updated transportation-value metric 208 reaches or satisfies an iteration threshold 210. If the updated transportation-value metric 208 has not reached the iteration threshold 210, the transportation matching system 104 runs a subsequent iteration by again adjusting an allocation of transportation providers and again generating an updated transportation-value metric. In such a subsequent iteration, for example, the transportation matching system 104 further adjusts the allocation of transportation providers 206 and generates a newly updated transportation-value metric differing from the updated transportation-value metric 208 based on the further adjusted allocation of transportation providers. If the updated transportation-value metric 208 reaches the iteration threshold 210, however, the transportation matching system 104 identifies a corresponding adjusted allocation of transportation providers as a final adjusted allocation of transportation providers 212 across the geocoded areas for the time period.

To determine whether iterative adjustments to an allocation of transportation providers or a transportation-value metric reaches the iteration threshold 210, in certain implementations, the transportation matching system 104 identifies a transportation-value-metric convergence. For example, in some embodiments, the transportation matching system 104 determines that updated transportation-value metrics have not increased in value after a threshold number of iterations (e.g., a maximum number of iterations). In certain implementations, the transportation matching system 104 permits some variance in increase in value after a threshold number of iterations (e.g., five iterations). In reaching the transportation-value-metric convergence, the transportation matching system 104 may accordingly determine that a series of updated transportation-value metrics have not increased in value more than (or equal to) a threshold variance after a threshold number of iterations.

In addition (or in the alternative) to progressing toward or reaching a transportation-value-metric convergence, in some embodiments, the transportation matching system 104 identifies a time threshold as the iteration threshold 210. For example, in some embodiments, the transportation matching system 104 determines that a maximum amount of time or a threshold amount of time has elapsed since initializing projections of transportation-provider allocations for a time period. Such a maximum or threshold amount of time can include any time period, such as ten seconds, thirty seconds, one minute, or five minutes. In certain implementations, the transportation matching system 104 determines that iterative adjustments have reached the iteration threshold 210 by determining that a threshold amount of time has elapsed since an initialization reference point—such as since initially generating a projected number of transportation requests for a time period, initially generating a projected allocation of transportation providers for the time period, or initially generating a transportation-value metric for the time period. Upon reaching a time threshold, in some embodiments, the transportation matching system 104 identifies an adjusted allocation of transportation providers corresponding to an updated transportation-value metric of a highest value or a highest rate from among iterations for the time period.

In certain implementations, the transportation matching system 104 determines that iterative adjustments have reached the iteration threshold 210 by determining that iterative adjustments have reached a transportation-value-metric convergence or a time threshold, whichever occurs sooner. For example, in some cases, the transportation matching system 104 adjusts an allocation of transportation providers across (and a transportation-value metric corresponding to) geocoded areas for a time period until reaching a point of convergence for the transportation-value metric—unless a threshold or maximum amount of time elapses sooner. If the transportation matching system 104 has not reached a transportation-value-metric convergence but has reached a time threshold, the transportation matching system 104 identifies a corresponding adjusted allocation of transportation providers as a final adjusted allocation of transportation providers 212 across the geocoded areas for the time period.

After reaching the iteration threshold 210 and identifying the final adjusted allocation of transportation providers 212, the transportation matching system 104 distributes instructions 214 associated with the final adjusted allocation of transportation providers 212 to transportation providers devices associated with transportation providers. For example, the transportation matching system 104 may send instructions to one or more of the provider client devices 110a-110n associated with the transportation vehicles 108a-108n, respectively, as illustrated in FIG. 1. As suggested above, in certain implementations, such instructions may come in the form of a graphical user interface identifying one or more transportation-rate inducements for one or more target geocoded areas or in the form of driving instructions for autonomous vehicles to travel to one or more target geocoded areas.

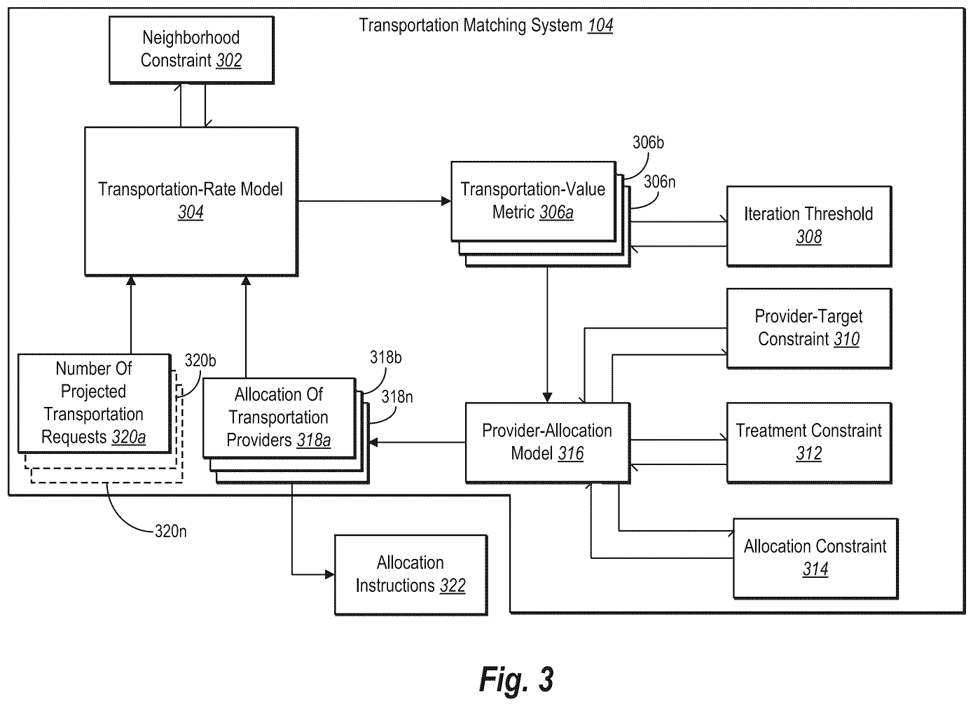

As noted above, in some embodiments, the transportation matching system 104 uses both a transportation-rate model and a provider-allocation model to iteratively adjust transportation-value metrics and transportation-provider allocations. In accordance with one or more embodiments, for instance, FIG. 3 illustrates the transportation matching system 104 using a transportation-rate model 304 and a provider-allocation model 316 to iteratively adjust a transportation-provider allocation across geocoded areas and generate a transportation-value metric corresponding to the geocoded areas subject to one or more constraints. Such constraints may include, for instance, a neighborhood constraint 302, a provider-target constraint 310, a treatment constraint 312, or an allocation constraint 314. Upon reaching an iteration threshold, the transportation matching system 104 identifies a corresponding final transportation-provider allocation and distributes allocation instructions 322 to provider client devices.

As shown in an initial iteration depicted in FIG. 3, for example, the transportation matching system 104 uses the transportation-rate model 304 to generate a transportation-value metric 306a corresponding to geocoded areas for a time period. In some embodiments, the transportation-rate model 304 generates the transportation-value metric 306a based on a number of projected transportation requests 320a across the geocoded areas for the time period and an allocation of transportation providers 318a across the geocoded areas for the time period. Accordingly, the number of projected transportation requests 320a represents a projected number of transportation requests to initialize an iteration. The allocation of transportation providers 318a represents a projected allocation of transportation providers to initialize an iteration.

To determine the number of projected transportation requests 320a and the allocation of transportation providers 318a, the transportation matching system 104 optionally relies on historical data for transportation requests and transportation-provider allocations. For example, the transportation matching system 104 may identify historical numbers of transportation requests and historical transportation-provider allocations across the geocoded areas from times and dates corresponding to the time period of interest. If the time period is 5:00 p.m. to 5:15 p.m. on Sunday, Jun. 21, 2020, for instance, the transportation matching system 104 may determine an average (or a weighted average) of transportation requests and transportation-provider allocations from the third Sunday in June from preceding years (e.g., the preceding two years). Alternatively, the transportation matching system 104 may use random numbers and randomized allocations—or a predetermined initial number and a predetermined initial allocation—as the number of projected transportation requests 320a and the allocation of transportation providers 318a, respectively, for an initial iteration.

As suggested above, in certain implementations, the transportation matching system 104 uses vectors to represent a number of projected transportation requests and one or more matrices to represent a transportation-provider allocation. For example, in some embodiments, a request vector for the number of projected transportation requests 320a comprises a series of numbers, where each number represents projected transportation requests for a particular geocoded area within a region. Similarly, in certain implementations, an allocation matrix for the allocation of transportation providers 318a comprises a series of numbers, where each number represents projected transportation providers for a particular geocoded area within a region.

As further indicated by FIG. 3, the transportation-rate model 304 generates the transportation-value metric 306a subject to the neighborhood constraint 302. In some embodiments, for instance, the neighborhood constraint 302 includes an adjacency-matrix mapping that compares transportation requests and available transportation providers within a geocoded neighborhood. By generating the transportation-value metric 306a subject to the neighborhood constraint 302, the transportation matching system 104 accounts for the allocation of transportation providers in geocoded areas neighboring the geocoded areas of interest for a given iteration.

After generating the transportation-value metric 306a in the initial iteration, the transportation matching system 104 uses the provider-allocation model 316 to generate an allocation of transportation providers 318b across the geocoded areas for the time period—based in part on the transportation-value metric 306a. To generate the allocation of transportation providers 318a, the provider-allocation model 316 can generate an allocation-flow matrix indicating transportation providers traveling from initial geocoded areas to target geocoded areas from among the geocoded areas for the time period.

In some embodiments, for instance, the provider-allocation model 316 (a) applies (i) a compliance probability of transportation providers traveling from the initial geocoded areas to the target geocoded areas to (ii) the allocation-flow matrix and (b) applies (i) a subset of transportation providers initially available for allocation across the geocoded areas for the time period to (ii) the product of the compliance probability and the allocation-flow matrix—as a basis for generating the allocation of transportation providers 318b. As just suggested, in some embodiments, the allocation of transportation providers 318a accordingly constitutes the subset of transportation providers initially available for allocation and takes the form of an allocation matrix.

As further shown in FIG. 3, the provider-allocation model 316 generates the allocation of transportation providers 318b subject to one or more of the provider-target constraint 310, the treatment constraint 312, or the allocation constraint 314. In some embodiments, the provider-target constraint 310 includes maximum and minimum values limiting expenditures per incremental transportation service for a time period. By contrast, in certain implementations, the treatment constraint 312 comprises maximum and minimum values for numbers of transportation requests across geocoded areas for the time period. Further, in some cases, the allocation constraint 314 comprises limits on values for an allocation-flow matrix in a given iteration. By generating the allocation of transportation providers 318b subject to the provider-target constraint 310, the treatment constraint 312, and the allocation constraint 314, the transportation matching system 104 accounts for limits on provider inducements, projected transportation requests, and allocations of transportation providers in a given iteration.

After generating the allocation of transportation providers 318b, the transportation matching system 104 runs through subsequent iterations by generating an updated transportation-value metric corresponding to the geocoded areas and by adjusting a transportation-provider allocation across the geocoded areas for the time period. As shown in FIG. 3, for example, the transportation-rate model 304 generates a transportation-value metric 306b based on the allocation of transportation providers 318b and the number of projected transportation requests 320a—subject to the neighborhood constraint 302. The provider-allocation model 316 further generates an allocation of transportation providers 318n based on the transportation-value metric 306b—subject to the provider-target constraint 310, the treatment constraint 312, and the allocation constraint 314.

As indicated by FIG. 3, in some cases, the transportation-rate model 304 uses adjusted numbers of projected transportation requests in subsequent iterations. The transportation matching system 104 may adjust numbers of projected transportation requests across geocoded areas, for example, based on a historical rate at which transportation requests increase or decrease based on a change in available transportation providers in a geocoded area and corresponding changes in price estimates for transportation. Accordingly, in some cases, the transportation-rate model 304 generates the transportation-value metric 306b based in part on a number of projected transportation requests 320b. In a subsequent iteration, the transportation-rate model 304 generates the transportation-value metric 306n based in part on a number of projected transportation requests 320n.

Either during each iteration or after an initial threshold number of iterations, the transportation matching system 104 can determine whether a transportation-value metric has reached an iteration threshold 308. Consistent with the disclosure above, in some embodiments, the transportation matching system 104 iteratively generates updated transportation-value metrics until determining that the transportation-value metrics have not increased in value after a threshold number of iterations (e.g., by not increasing in value more than or equal to a threshold variance). Alternatively, the transportation matching system 104 iteratively generates updated transportation-value metrics until a threshold amount of time has elapsed since initializing transportation-provider projections or transportation-request projections for a time period. Upon identifying a transportation-value metric that has not increased in value after a threshold number of iterations or identifying a threshold amount of time has elapsed, the transportation matching system 104 reaches the iteration threshold.

Upon generating a transportation-value metric 306n, in certain implementations, the transportation matching system 104 determines that updated transportation-value metrics have not increased in value after a threshold number of iterations and have reached the iteration threshold. The transportation matching system 104 subsequently identifies the allocation of transportation providers 318n as a final allocation of transportation providers. The allocation of transportation providers 318n corresponds to and serves as a basis for the transportation-value metric 306n. Based on the allocation of transportation providers 318n, the transportation matching system 104 distributes allocation instructions 322 to provider client devices, such as by distributing heatmaps identifying transportation-rate inducements or distributing driving instructions to one or more of the provider client devices 110a-110n shown in FIG. 1.

As indicated above, the transportation-rate model 304 depicted in FIG. 3 can take a variety of forms and generate a transportation-value metric in a variety of formats. For example, in some embodiments, a transportation-value metric constitutes a booking metric indicating a quantity of transportation requests projected for receipt from requestors (or for acceptance by providers) across geocoded areas in a time period. Alternatively, in some cases, a transportation-value metric constitutes a conversion metric indicating a projected quantity or a projected rate at which transportation requests result in completed transportation services across geocoded areas in a time period. As a further alternative, in certain applications, a transportation-value metric constitutes a profit metric or a revenue metric indicating a projected quantity of profit or revenue for matching transportation requests to transportation providers across geocoded areas in a time period (e.g., upon completion of service).

The booking metric, conversion metric, profit metric, and revenue metric are merely examples of a transportation-value metric. The transportation matching system 104 may use any suitable transportation-value metric to measure the efficiency or value of allocating transportation providers in a particular distribution across geocoded areas within a region.

To further illustrate the transportation-rate model 304, in certain implementations, the transportation-rate model 304 uses an objective function to generate a transportation-value metric. By running through multiple iterations, the transportation-rate model 304 optimizes the objective function as equal to one or more of a transportation-value metric based on projected transportation requests and projected transportation providers for a time period. In some cases, for example, the transportation-rate model 304 generates a transportation-value metric for a time period based on a number of projected transportation requests across geocoded areas, a base-conversion metric from a conversion learner, a conversion-reduction metric from the conversion learner, and an allocation-flow matrix indicating transportation providers traveling from initial geocoded areas to target geocoded areas.

In some embodiments, a base-conversion metric represents a probability that a requestor who submits a transportation request (or is anticipated to submit a request) will be matched to a transportation provider and/or complete transportation with a transportation provider. By contrast, a conversion-reduction metrics can represent a coefficient or amount of reduction in conversion rates based on historical market data. The transportation-rate model 304 can receive the base-conversion metric and the conversion-reduction metric as a base conversion rate and a conversion reduction amount used by a conversion learner, as described by Davide Crapis et al., Improving Efficiency of a Transportation Matching System Using Geocoded Provider Models, U.S. application Ser. No. 16/125,527 (filed Sep. 7, 2018) (hereinafter “Crapis”), the entire contents of which are incorporated by reference. Further, in certain cases, the transportation-rate model 304 receives the base-conversion metric and the conversion-reduction metric as conversion parameters from a conversion learner, as described by Ricky Chachra et al., Dynamically Generating and Updating Multipliers for a Transportation Matching System Using Machine Learning, U.S. application Ser. No. 15/810,028 (filed Nov. 11, 2017) (hereinafter “Chachra”), the entire contents of which are incorporated by reference.

To illustrate the objective function from the transportation-rate model 304, in some embodiments, the transportation-rate model 304 optimizes the objective function to include or determine a transportation-value metric in part by (a) transposing the product of: (i) a request vector for a number of projected transportation requests across geocoded areas, (ii) a base-conversion metric, and (iii) a conversion-reduction metric subtracted from the value one, where the subtraction output is raised to a logarithm of an initial transportation-value metric divided by twenty five; (b) determining a product of: (i) a penalty factor for the transportation-value metric and (ii) the squared Euclidean norm of the transportation-value metric; and (c) determining a product of: (i) a penalty factor for the allocation of transportation providers and (ii) the Euclidean norm of the allocation-flow matrix indicating transportation providers traveling from initial geocoded areas to target geocoded areas. The objective function further subtracts the products determined in (b) and (c) from the transposed product determined in (a) to output a transportation-value metric in a given iteration.

The objective function can be expressed in alternative formats. For example, in some cases, the transportation matching system 104 convexifies the objective function by replacing the initial transportation-value metric with a replacement variable. The replacement variable may be the conversion-reduction metric subtracted from the value one, where the subtraction output is raised to a logarithm of an initial transportation-value metric divided by twenty five. When using such a replacement variable, the transportation matching system 104 optionally uses the Operator Splitting Quadratic Program (“QP”) Solver to solve the objective function, as described by Bartolomeo Stellato et al., “OSQP: An Operator Splitting Solver for Quadratic Programs,” 2018 UKACC 12th Int'l Conf. on Control (2018), the entire contents of which are incorporated by reference.

In addition to an objective function, in certain implementations, the transportation matching system 104 uses multiple factors to determine the neighborhood constraint 302. For example, the transportation matching system 104 can determine the neighborhood constraint 302 based on an adjacency-matrix mapping that compares projected transportation requests and available transportation providers within a geocoded neighborhood, a request vector for a number of projected transportation requests across geocoded areas, a base-conversion metric, a conversion-reduction metric, and subsets of transportation providers respectively available and unavailable for allocation across the geocoded areas for the time period.

In particular, in some cases, the transportation matching system 104 uses a partial ordering or a partially ordered set for all (or part) of the neighborhood constraint 302. To configure the neighborhood constraint 302, for example, the transportation matching system 104 (a) determines a product of: (i) an adjacency-matrix mapping, (ii) a request vector for a number of projected transportation requests, (iii) a base-conversion metric, and (iv) a conversion-reduction metric subtracted from the value one, where the subtraction output is raised to a logarithm of an initial transportation-value metric divided by twenty five; (b) determines (i) the sum of the adjacency matrix applied to a subset of transportation providers available for allocation across the geocoded areas for the time period and the adjacency-matrix mapping applied to a subset of transportation providers unavailable for allocation across the geocoded areas for the time period, (ii) an allocation of reserved transportation providers across the geocoded areas for the time period, (iii) a supply-learner-intercept factor from a supply learner, and (iv) a supply-learner-slope factor from the supply learner; (c) subtracts the supply-learner-intercept factor and the allocation of reserved transportation providers from the sum determined in (b) (i); and (d) determines a product of: (i) the supply-learner-slope factor from the supply learner and (ii) the output from (c).

To further determine the neighborhood constraint 302, the transportation matching system 104 performs the determinations and subtractions in (a), (b), (c), and (d) from the preceding paragraph such that the product of (a) is less than or equal to the product of (d)—where the initial transportation-value metric is more than or equal to zero and less than or equal to a maximum-transportation-value metric. To determine the supply-learner-intercept factor, in some cases, the transportation matching system 104 determines a net flow of transportation providers into a geographic neighborhood corresponding to the geocoded areas. To determine the supply-learner-slope factor, in some cases, the transportation matching system 104 determines an average number of transportation requests a transportation provider can service—including transportation providers grouping multiple transportation requests in a shared transportation service. As a reference, in certain implementations, the transportation matching system 104 uses the supply-learner-intercept factor and the supply-learner-slope factor as described by Crapis.

As further indicated above, the provider-allocation model 316 can take a variety of forms and generate an allocation of transportation providers in a variety of formats. For each geocoded area within a region, for example, the transportation matching system 104 can transpose a product of (i) a compliance probability of transportation providers traveling to or from the geocoded area to one or more target geocoded areas, (ii) an allocation-target metric (e.g., an expected-bonus payout to transportation providers), (iii) an allocation-flow matrix indicating transportation providers traveling from initial geocoded areas to target geocoded areas from among the geocoded areas for the time period, and (iv) a subset of transportation providers initially available for allocation in the geocoded area for the time period. As suggested above, in some embodiments, an allocation-target metric refers to a metric measuring expected-bonus payouts to transportation providers attributable to a transportation-value metric for transportation providers complying with distributed instructions (e.g., travel to a geocoded area based on a heat map indicating incremental accumulation metrics) or an allocation-flow matrix. Accordingly, in some embodiments, the provider-allocation model 316 generates an allocation of transportation providers by generating an allocation matrix comprising the transposed product of (i), (ii), (iii), and (iv) for each geocoded area within a region. In some cases, the transportation matching system 104 determines the compliance probability for this or other embodiments based on estimated travel times between geocoded areas.

To determine a compliance probability, in some embodiments, the transportation matching system 104 uses a probabilistic model to project where transportation providers will be located across geocoded areas of a region for a time period. Given a transportation-value metric or an allocation-target metric, an original or current location of a transportation provider, and a destination location for the transportation provider, the probabilistic model projects a geocoded area within which the transportation provider will be located for a time period. Based on a projected location for each transportation provider across the geocoded areas, the transportation matching system 104 determines a compliance probability of transportation providers traveling to or from a geocoded area to one or more target geocoded areas. Alternatively, in some embodiments, the transportation matching system 104 assumes that transportation providers that do not comply with an allocation-flow matrix or other provider-target instructions.

Alternatively, in some embodiments, the provider-allocation model 316 generates an allocation of transportation providers in part by (a) applying (i) a compliance probability of transportation providers traveling from the initial geocoded areas to the target geocoded areas to (ii) an allocation-flow matrix indicating transportation providers traveling from initial geocoded areas to target geocoded areas for the time period; (b) applying (i) a subset of transportation providers initially available for allocation across the geocoded areas for the time period to (ii) the product of the compliance probability and the allocation-flow matrix; (c) generating a diagonal matrix from the transposed product of (i) the compliance probability and (ii) the allocation-flow matrix; (d) subtracting the diagonal matrix from a unity matrix; and (e) applying the subset of transportation providers initially available for allocation to the resulting matrix from (d). To generate the allocation of transportation providers, the provider-allocation model 316 further sums the matrix produced by (a) and (b) to the matrix produced by (e).

As noted above, in certain implementations, the provider-allocation model 316 generates an allocation of transportation providers subject to the provider-target constraint 310. In some embodiments, for instance, the provider-target constraint 310 stipulates that (I) the transposed product of (a) applying a compliance probability to (i) an allocation-flow matrix and (ii) a provider-inventive metric and (b) applying a subset of transportation providers initially available for allocation to the product of the compliance probability and the allocation-flow matrix must be (II) more than or equal to a minimum-provider-inducement value and (III) less than or equal to a maximum-provider-inducement value.

As further noted above, in certain implementations, the provider-allocation model 316 generates an allocation of transportation providers subject to the treatment constraint 312. In some embodiments, the treatment constraint 312 stipulates that (a) the transposed product of (i) applying a compliance probability to an allocation-flow matrix and (ii) applying a subset of transportation providers initially available for allocation to the product of the compliance probability and the allocation-flow matrix must be (b) more than or equal to a minimum number of projected transportation requests across the geocoded areas and (c) less than or equal to a maximum number of projected transportation requests across the geocoded areas.

In addition (or in the alternative) to the provider-target constraint 310 and the treatment constraint 312, in certain implementations, the provider-allocation model 316 generates an allocation of transportation providers subject to the allocation constraint 314. In some cases, the allocation constraint 314 comprises a partially ordered set in which (a) the transposed product of an allocation-flow matrix is less than or equal to the allocation-flow matrix and (b) the allocation-flow matrix is more than or equal to a zero value.

As noted above and depicted in FIG. 3, the transportation matching system 104 iteratively adjusts an allocation of transportation providers across geocoded areas for a time period. In some cases, the transportation matching system 104 represents such an allocation of transportation providers in an allocation matrix. In accordance with one or more embodiments, FIGS. 4A and 4B respectively illustrate an initial allocation of transportation providers across geocoded areas as an initial allocation matrix 400a and a final allocation of transportation providers across the geocoded areas as a final allocation matrix 400b.

As shown in FIG. 4A, for example, the transportation matching system 104 generates the initial allocation matrix 400a to represent an initial allocation of transportation providers across geocoded areas within a region 406a. For illustrative purposes, FIG. 4A depicts the initial allocation matrix 400a over a map representing geocoded areas for the region 406a. As generated in an iterative process, however, the initial allocation matrix 400a can comprise values arranged in rows and columns, where each value indicates a number of transportation providers for a particular geocoded area. Such an allocation matrix accordingly does not include an underlying map.

As indicated by FIG. 4A, the initial allocation matrix 400a includes a number of transportation providers for each geocoded area within the region 406a. A geocoded area 402a, for example, corresponds to a number of transportation providers 404a. Because the initial allocation matrix 400a represents an initial allocation of providers in an iterative process, however, the transportation matching system 104 adjusts values for the number of transportation providers corresponding to one or more geocoded areas from iteration to iteration. FIG. 4B depicts a final adjustment of such adjusted values.

As shown in FIG. 4B, for example, the transportation matching system 104 generates the final allocation matrix 400b to represent a final allocation of transportation provides across the geocoded areas within the region 406b. The region 406b shown in FIG. 4B represents the same region as the region 406a in FIG. 4A, but at a different iteration. For illustrative purposes, FIG. 4B similarly depicts the final allocation matrix 400b over a map representing geocoded areas for the region 406b. As generated in an iterative process, however, the final allocation matrix 400b can comprise adjusted values arranged in rows and columns, where each adjusted value indicates an adjusted number of transportation providers for a particular geocoded area. In some cases, the adjusted number of transportation providers for a particular geocoded area may have the same value as an initial number of transportation providers—depending on how the transportation matching system 104 adjusts such values.

As indicated by FIG. 4B, the final allocation matrix 400b includes an adjusted number of transportation providers for each geocoded area within the region 406b. A geocoded area 402b shown in FIG. 4B, for example, represents the same geocoded area as the geocoded area 402a in FIG. 4A, but at a different iteration. As further indicated by FIG. 4B, the geocoded area 402b corresponds to an adjusted number of transportation providers 404b. As shown by a comparison of the initial allocation matrix 400a and the final allocation matrix 400b, the transportation matching system 104 adjusts values for the number of transportation providers corresponding to the geocoded area 402a (and for other geocoded areas) as the transportation matching system 104 iterates through allocations of transportation providers across the geocoded areas for a time period. In some cases, if a final allocation matrix adjusts values for a particular geocoded area less than a threshold change in value (e.g., 5%), the transportation matching system 104 disregards the adjusted value for purposes of the final allocation matrix.

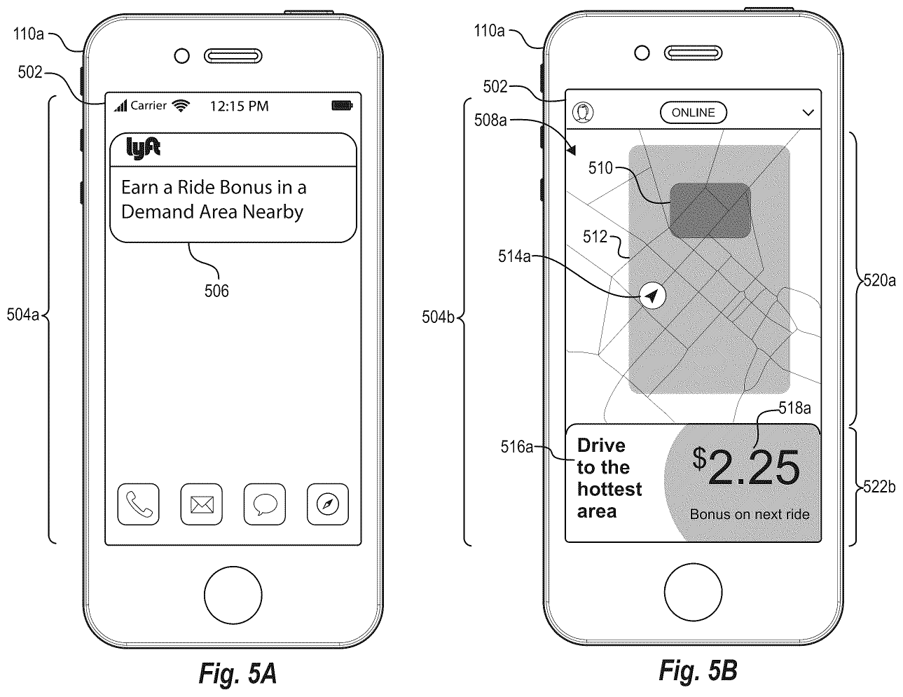

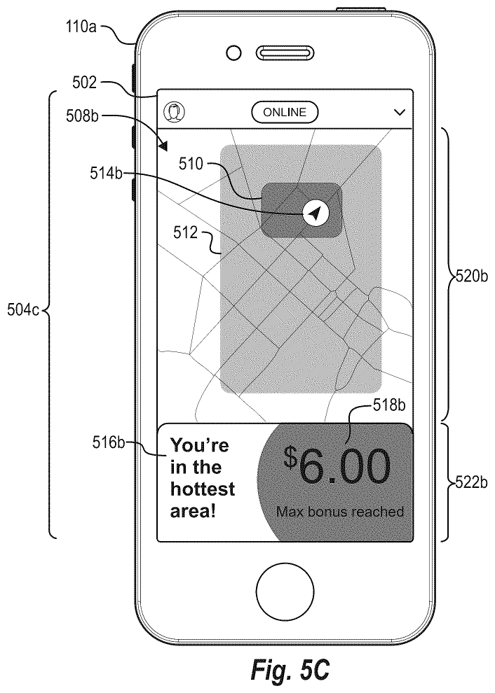

As noted above, the transportation matching system 104 can distribute instructions associated with a final adjusted allocation of transportation providers to one or more provider client devices. In some cases, the transportation matching system 104 sends instructions to a provider client device that (upon execution) cause the provider client device to present a graphical user interface identifying one or more transportation-rate inducements for one or more target geocoded areas. In accordance with one or more embodiments, FIGS. 5A-5C depict a provider client device presenting graphical user interfaces notifying a provider of (or identifying) a provider-rate inducement for target geocoded areas. As an overview, FIGS. 5A-5C each depict the provider client device 110a comprising the provider client application 112a for the transportation matching system 104. The provider client application 112a comprises computer-executable instructions that cause the provider client device 110a to perform certain actions depicted in FIGS. 5A-5C.

Rather than repeatedly describe the computer-executable instructions within the provider client application 112a as causing the provider client device 110a to perform such actions, this disclosure primarily describes the provider client device 110a or the transportation matching system 104 as performing the actions as a shorthand. While the provider client device 110a appears as a mobile device (e.g., smartphone) in FIGS. 5A-5C, the provider client device 110a may alternatively be any type of computing device, such as a desktop, laptop, or tablet, and may also detect any suitable user interaction, including, but not limited to, an audio input into a microphone, a keyboard input, a mouse click, a stylus interaction with a touch screen, or a touch gesture on a touch screen.

As shown in FIG. 5A, for example, the provider client device 110a presents a graphical user interface 504a comprising a notification 506 within a screen 502. The notification 506 may constitute a push notification or a pull notification. Accordingly, the transportation matching system 104 can either push the notification 506 to the provider client device 110a or receive a pull from the provider client device 110a before sending the notification 506. After identifying a final adjusted allocation of transportation providers, in some embodiments, the transportation matching system 104 sends the notification 506 to the provider client device 110a to notify the provider 114a of available provider-rate inducements for one or more geocoded regions. In this particular embodiment, the notification 506 states, “Earn a Ride Bonus in a Demand Area Nearby.” But the transportation matching system 104 may use any other suitable language in notifications of provider-rate inducements.

As indicated by FIG. 5A, in some embodiments, the notification 506 includes a selectable option that, when selected by the provider 114a, causes the provider client device 110a to present a graphical user interface for a map identifying provider-rate inducements by location or zone. In response to a user interaction with such a selectable option, for example, the provider client device 110a can open the provider client application 112a—before presenting a graphical user interface including a map identifying provider inducements for geocoded areas. FIG. 5B depicts an example of the provider client device 110a presenting such a graphical user interface based on detecting a user interaction with the notification 506.

As illustrated in FIG. 5B, the provider client device 110a presents a graphical user interface 504b comprising a mapping interface portion 520a and an accumulation interface portion 522a within the screen 502. The mapping interface portion 520a includes a map 508a that includes an inner zone 510, an outer zone 512, and a provider location 514a (i.e., current location). In some cases, the map 508a constitutes a heat map identifying different zones in different colors or shades. The accumulation interface portion 522a of the graphical user interface 504b includes inducement instructions 516a and an incremental accumulation metric 518a.

In some implementations, the transportation matching system 104 generates the graphical user interface 504b for a selected transportation provider to incentivize the transportation provider to travel from the provider location 514a to a target area indicated by the inner zone 510. Consistent with the disclosure above, the target area indicated by the inner zone 510 may include one or more target geocoded areas. In response to detecting the transportation vehicle 108a (and the provider client device 110a) traveling to the target area, the transportation matching system 104 offers a bonus inducement (or an accumulation incentive) for one or both of accepting a transportation request and for transporting a requestor to a destination. The bonus inducement in the incremental accumulation metric 518a accordingly incentivizes the provider 114a to travel to one or more target geocoded areas from an initial target geocoded area based on a final adjusted allocation of transportation providers.

As indicated in FIG. 5B, in certain implementations, the map 508a is centered on or includes a full view of the target area (identified by the inner zone 510) and remains fixed while the provider location 514a changes to reflect the movement of the transportation vehicle 108a and the provider client device 110a. In alternative embodiments, the map 508a is centered around the provider location 514a. But the transportation matching system 104 can scale the map 508a for the graphical user interface 504b to display both the provider location 514a and the full border of the zone within which the provider 114a is currently located (or all zones, if not within any zone). As the transportation vehicle 108a (and the provider client device 110a) cross into smaller zones, the transportation matching system 104 can accordingly zoom in on the map 508a to show the current zone and any interior zones.

In some cases, the transportation matching system 104 updates the inducement instructions 516a to direct a transportation provider to keep traveling toward the target area or to notify a transportation provider upon arrival at the target area. FIG. 5C depicts an example of the transportation matching system 104 notifying the provider 114a upon arrival at the target area. As illustrated in FIG. 5C, the provider client device 110a presents a graphical user interface 504c comprising a mapping interface portion 520b and an accumulation interface portion 522b within the screen 502. The mapping interface portion 520b includes an updated map 508b indicating a provider location 514b within the inner zone 510. The transportation matching system 104 accordingly updates the inducement instructions 516b to notify the provider 114a that the provider client device 110a has arrived at the target area (e.g., “You're in the hottest area!”).

As further indicated by the accumulation interface portion 522b, an incremental accumulation metric 518b has increased to $6.00 based on the time the provider 114a spent in the inner zone 510. The incremental accumulation metric 518b further indicates that the provider 114a has reached the maximum accumulation amount (e.g., “Max bonus reached”). In some cases, the transportation matching system 104 matches the provider 114a with a transportation request originating from the target area at or before the provider 114a reaches the maximum accumulation metric.

As shown in FIGS. 5A and 5B, the graphical user interfaces 502a and 502b provide examples of graphical user interfaces from the transportation matching system 104. In some embodiments, the transportation matching system 104 sends instructions to a provider client device that (upon execution) cause the provider client device to present a customized provider interface for a particular transportation provider identifying a transportation-rate inducement, as described by Crapis. Indeed, in some embodiments, graphical user interfaces 502a and 502b constitute customized provider interfaces for the provider 114a.

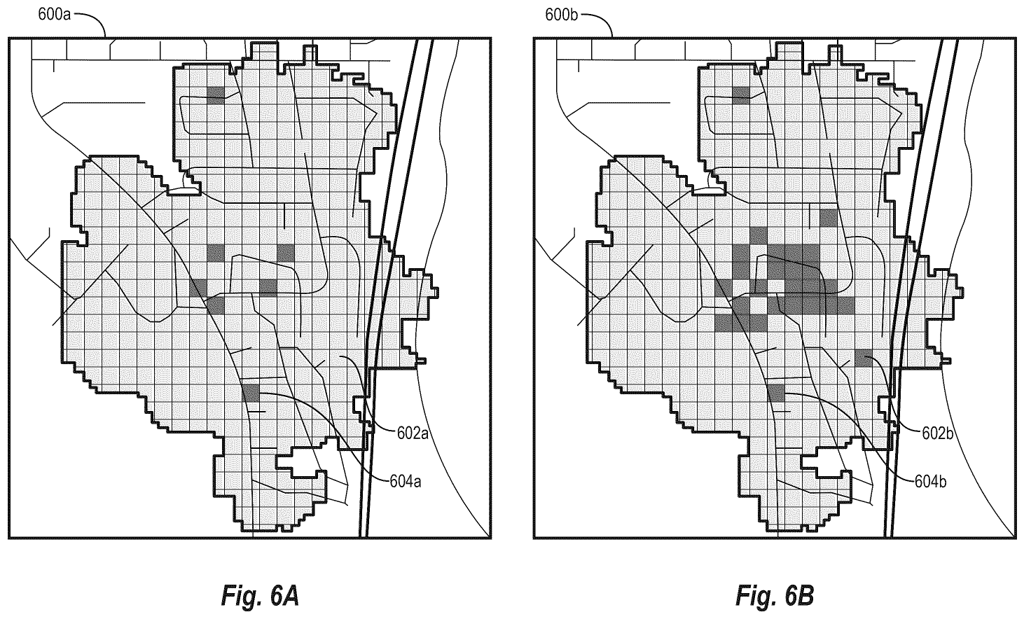

As noted above, in certain implementations, the transportation matching system 104 improves the accuracy and efficiency with which a transportation-network system allocates transportation providers across geocoded areas in terms of a transportation-value metric. To test the accuracy and efficiency of the transportation matching system 104, researchers compared (i) a static transportation-network system using an objective function from a transportation-rate model without a provider-allocation model and without an iterative process and (ii) the transportation matching system 104 using both a transportation-rate model and a provider-allocation model in an iterative process consistent with FIG. 3. FIGS. 6A and 6B respectively illustrate a conversion-gain-plot map 600a and a conversion-gain-plot map 600b depicting results from such a comparison in terms of a conversion metric as the transportation-value metric.

To generate the conversion-gain-plot maps 600a and 600b, researchers performed an offline simulation to determine conversion metrics across geocoded areas for a time period using the static transportation-network system and the transportation matching system 104 as just described. The researchers performed the offline simulation for geocoded areas in a metropolitan area of the United States that regularly experiences high volumes of transportation requests. To compare the different systems, the researchers used the static transportation-network system to determine a conversion metric corresponding to geocoded areas (within multiple regions) for a time period of high-volume transportation requests—based on a projected allocation of transportation providers from historical data. The researchers also used the transportation matching system 104 to determine a conversion metric corresponding to the same geocoded areas (within the same multiple regions) for the time period—based on a final adjusted allocation of transportation providers generated in an iterative process, such as that depicted in FIG. 3.

In FIG. 6A, the conversion-gain-plot map 600a depicts representative results for the static transportation-network system. In FIG. 6B, the conversion-gain-plot map 600b depicts representative results for the transportation matching system 104. In both cases, the conversion-gain-plot map represents the positive part of the difference between expected per-geocoded-area conversions resulting from the static transportation-network system and per-geocoded-area conversions resulting from the transportation matching system 104 with a “cleaning” adjustment, as explained below.

As shown in FIG. 6A, the conversion-gain-plot map 600a includes shaded conversion-percentile indicators for regions within the metropolitan area during the time period. For example, a region 602a includes a conversion-percentile indicator in a lighter shade. By contrast, a region 604a includes a conversion-percentile indicator in a darker shade. The darker shaded conversion-percentile indicators signal a higher conversion rate within a particular percentile than the lighter shaded conversion-percentile indicator in a different percentile according to historical conversion rates.

As shown in FIG. 6B, the conversion-gain-plot map 600b also includes shaded conversion-percentile indicators for regions within the metropolitan area during the same time period. Regions 602b and 604b in FIG. 6B are the same regions as the regions 602a and 604a in FIG. 6A, except the conversion metrics corresponding to the conversion-percentile indicators in the regions 602b and 604b are determined by the transportation matching system 104 instead of the static transportation-network system. In contrast to the conversion-gain-plot map 600a from FIG. 6A, both the regions 602b and 604b in the conversion-gain-plot map 600b from FIG. 6B include darker shaded conversion-percentile indicators. Indeed, the conversion-gain-plot map 600b includes more conversion-percentile indicators in darker shades for regions than the conversion-gain-plot map 600a. This increase indicates that the transportation matching system 104 generates a final allocation of transportation providers resulting in higher conversion rates than the static transportation-network system.

In particular, the researchers determined that the transportation-provider allocation from the transportation matching system 104 resulted in a 2.0% increase in conversions over the transportation-provider allocation from the static transportation-network system. In its transportation-provider allocation, the transportation matching system 104 allocated more transportation providers near a center “hotspot” to adjust for increased volume of transportation requests. The transportation matching system 104 accordingly generated a more accurate and efficient allocation of transportation providers than the static transportation-network system.

In a further test, the researchers used the transportation matching system 104 to determine a conversion metric corresponding to the same geocoded areas (within the same multiple regions) for the time period based on a final adjusted allocation of transportation providers generated in an iterative process—but with a “cleaning” adjustment. In the cleaning adjustment, the transportation matching system 104 disregards an adjusted value representing an allocation of transportation providers within a particular geocoded area (e.g., in an allocation matrix)—if a final allocation of transportation providers adjusts values for a particular geocoded area less than 5% in value. Such a cleaning adjustment attempts to prevent the transportation matching system 104 from allocating transportation providers due to a numerical inaccuracy. The researchers determined that the transportation-provider allocation with such a cleaning adjustment from the transportation matching system 104 resulted in a 2.4% increase in conversions over the transportation-provider allocation from the static transportation-network system. While the offline simulations capture noisy input signals, the results indicate improved accuracy and efficiency from the transportation matching system 104 over a static model.

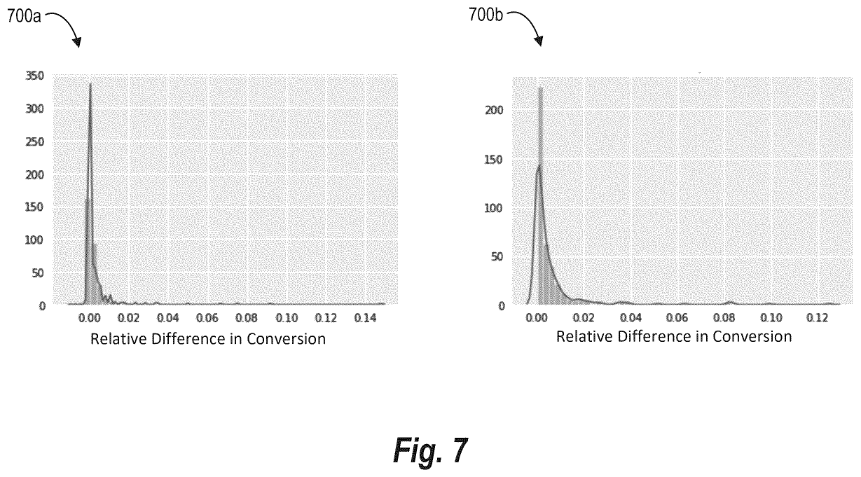

To further test the accuracy and efficiency of the transportation matching system 104, researchers ran samples for multiple time periods through the static transportation-network system, the transportation matching system 104 without a cleaning adjustment, and the transportation matching system 104 with a cleaning adjustment to determine transportation-value metrics. FIG. 7 illustrates graphs demonstrating results from such samples. In general, FIG. 7 illustrates graphs demonstrating improved conversion rates across geocoded areas for samples processed by the transportation matching system 104 without a cleaning adjustment and the transportation matching system 104 with a cleaning adjustment in accordance with one or more embodiments.

To facilitate comparing differences between systems in terms of transportation-value metrics, the researchers applied the static transportation-network system and different embodiments of the transportation matching system 104 to 283 sample datasets for transportation requests across the geocoded areas from the metropolitan area for multiple time periods. To identify the 283 sample datasets, the researchers selected the top three busiest time periods in each day of a three-month span on which to run an objective function to determine transportation-value metrics based on transportation-provider allocations from the static transportation-network system and different embodiments of the transportation matching system 104. Each system solved an objective function to determine a transportation-value metric for each sample using the Operator Splitting QP Solver on a computing device comprising r5d.24xlarge instances with 48 cores and 768 gibibytes of memory.

More than 200 of the 283 sample datasets fed to the static transportation-network system and different embodiments of the transportation matching system 104 include time periods corresponding to positive samples in which transportation requests exceeded the number of available transportation providers across the geocoded areas. Less than twenty of the 283 sample datasets fed to the static transportation-network system and different embodiments of the transportation matching system 104 include time periods corresponding to negative samples in which transportation requests fell below the number of available transportation providers across the geocoded areas.

As shown in FIG. 7, a conversion graph 700a indicates that the transportation matching system 104 without cleaning adjustment improved a projected conversion rate from transportation requests to completed service in comparison to the static transportation-network system. In particular, the transportation matching system 104 without cleaning adjustment improved the projected conversion rate by 0.235% in comparison to the static transportation-network system. As further shown in FIG. 7, a conversion graph 700b indicates that the transportation matching system 104 with cleaning adjustment also improved the projected conversion rate from transportation requests to completed service in comparison to the static transportation-network system. In particular, the transportation matching system 104 without cleaning adjustment improved the projected conversion rate by 0.442% in comparison to the static transportation-network system.

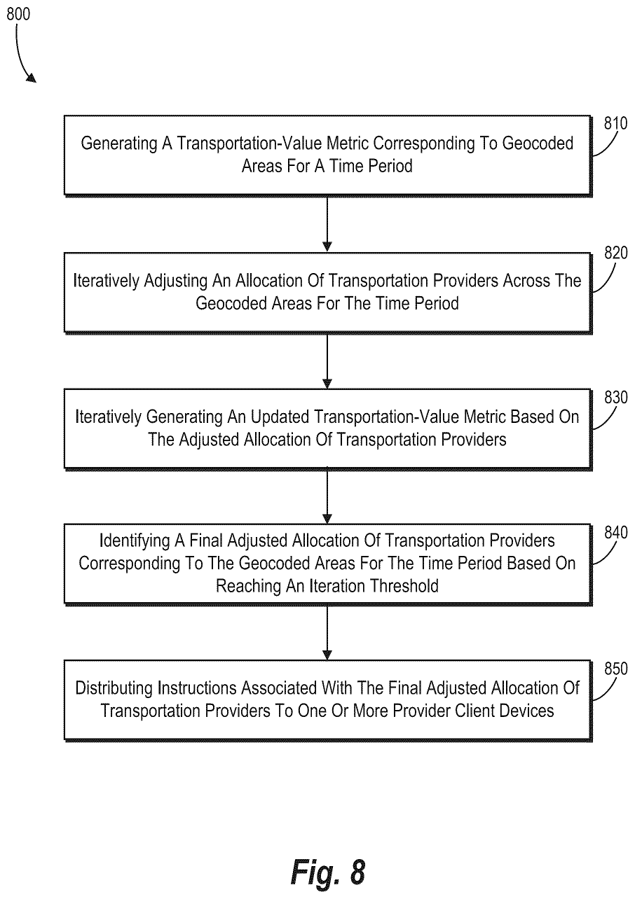

Turning now to FIG. 8, this figure illustrates a flowchart of a series of acts 800 of a transportation matching system iteratively adjusting an allocation of transportation providers across geocoded areas for a time period until identifying a final allocation of transportation providers corresponding to an improved transportation-value metric corresponding to the geocoded areas in accordance with one or more embodiments. While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer readable storage medium can comprise instructions that, when executed by one or more processors, cause a computing device to perform the acts depicted in FIG. 8. In still further embodiments, a system can perform the acts of FIG. 8.

As shown in FIG. 8, the acts 800 include an act 810 of generating a transportation-value metric corresponding to geocoded areas for a time period. In particular, in some embodiments, the act 810 includes generating a transportation-value metric corresponding to a set of geocoded areas for a time period based on a projected allocation of transportation providers across the set of geocoded areas.

As further shown in FIG. 8, the acts 800 include an act 820 of iteratively adjusting an allocation of transportation providers across the geocoded areas for the time period. In particular, in some embodiments, the act 820 includes, until reaching an iteration threshold, iteratively adjusting an allocation of transportation providers across the set of geocoded areas for the time period.

In some embodiments, adjusting the allocation of transportation providers across the set of geocoded areas for the time period comprises generating an allocation-flow matrix indicating one or more transportation providers traveling from initial geocoded areas to target geocoded areas. Further, in some cases, adjusting the allocation of transportation providers across the set of geocoded areas for the time period further comprises determining a compliance probability indicating a likelihood that transportation providers travel from an initial geocoded area to a target geocoded area in compliance with provider-target instructions. In particular, in some such cases, adjusting the allocation of transportation providers across the set of geocoded areas for the time period further comprises determining a compliance probability indicating a likelihood that transportation providers travel from an initial geocoded area to a target geocoded area in compliance with the allocation-flow matrix.

Additionally, in one or more embodiments, adjusting the allocation of transportation providers across the set of geocoded areas for the time period further comprises generating an allocation-target metric indicating inducements for available transportation providers to travel to target geocoded areas. Relatedly, in certain implementations, adjusting the allocation of transportation providers across the set of geocoded areas for the time period comprises generating the adjusted allocation of transportation providers based on one or more of an allocation-flow matrix indicating one or more transportation providers traveling from initial geocoded areas to target geocoded areas; a compliance probability indicating a likelihood that the one or more transportation providers travel from an initial geocoded area to a target geocoded area in compliance with provider-target instructions; an allocation-target metric indicating inducements for available transportation providers to travel to the target geocoded areas; a subset of transportation providers initially available for allocation across the set of geocoded areas for the time period; or a subset of transportation providers unavailable for allocation across the set of geocoded areas for the time period.

As further shown in FIG. 8, the acts 800 include an act 830 of iteratively generating an updated transportation-value metric based on the adjusted allocation of transportation providers. In particular, in certain implementations, the act 830 includes, until reaching an iteration threshold, iteratively generating an updated transportation-value metric based on the adjusted allocation of transportation providers. In some implementations, generating the transportation-value metric corresponding to the set of geocoded areas for the time period comprises generating a booking metric, a conversion metric, a profit metric, or a revenue metric.

As further shown in FIG. 8, the acts 800 include an act 840 of identifying a final adjusted allocation of transportation providers corresponding to the geocoded areas for the time period based on reaching an iteration threshold. In particular, in certain implementations, the act 840 includes, based on reaching the iteration threshold, identifying a final adjusted allocation of transportation providers corresponding to the set of geocoded areas for the time period. In some embodiments, reaching the iteration threshold comprises reaching a transportation-value-metric convergence or reaching a time threshold.

As further shown in FIG. 8, the acts 800 include an act 850 of distributing instructions associated with the final adjusted allocation of transportation providers to one or more provider client devices. In particular, in some embodiments, the act 850 includes distributing instructions associated with the final adjusted allocation of transportation providers to one or more provider client devices associated with one or more corresponding transportation providers.

In some embodiments, the act 850 includes distributing instructions associated with the final adjusted allocation of transportation providers for display on one or more provider client devices associated with one or more corresponding transportation providers. Additionally, or alternatively, in certain implementations, the act 850 includes distributing instructions associated with the final adjusted allocation of transportation providers to one or more provider client devices associated with one or more corresponding autonomous vehicles. Further, in one or more embodiments, the act 850 includes distributing instructions associated with the final adjusted allocation of transportation providers to one or more provider client devices for display on one or more graphical user interfaces associated with one or more corresponding transportation providers or for direction of one or more autonomous vehicles.

For example, in some cases, distributing the instructions associated with the final adjusted allocation of transportation providers to one or more provider client devices comprises transmitting sets of instructions to provider client devices associated with autonomous vehicles to travel to one or more target geocoded areas. Additionally, or alternatively, in some embodiments, distributing the instructions associated with the final adjusted allocation of transportation providers to one or more provider client devices comprises providing, to a set of provider client devices, a graphical user interface identifying one or more transportation-rate inducements for one or more target geocoded areas.

In addition to the acts 810-850, in certain implementations, the acts 800 further include generating the transportation-value metric corresponding to the set of geocoded areas for the time period based in part on a projected number of transportation requests across the set of geocoded areas for the time period. Similarly, in certain implementations, the acts 800 further include generating the transportation-value metric corresponding to the set of geocoded areas for the time period based in part on a projected number of transportation requests across the set of geocoded areas for the time period; and generating the updated transportation-value metric based in part on an adjusted projected number of transportation requests across the set of geocoded areas for the time period.

As suggested above, in some embodiments, the acts 800 further include adjusting the allocation of transportation providers across the set of geocoded areas for the time period based in part on one or more of an allocation constraint, a provider-target constraint, a neighborhood constraint, or a treatment constraint. Similarly, in certain implementations, the acts 800 further include generating the updated transportation-value metric based on the adjusted allocation of transportation providers subject to a neighborhood constraint.

Further, in one or more embodiments, the acts 800 further include identifying the iteration threshold by determining that updated transportation-value metrics have not increased in value after a threshold number of iterations. Similarly, in some implementations, the acts 800 further include identifying the iteration threshold by determining that updated transportation-value metrics have not increased in value more than (or equal to) a threshold variance after a threshold number of iterations.

Embodiments of the present disclosure may comprise or utilize a special-purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or generators and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface generator (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural marketing features and/or methodological acts, it is to be understood that the subject matter defined in the appended claims is not necessarily limited to the described marketing features or acts described above. Rather, the described marketing features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program generators may be located in both local and remote memory storage devices.

Embodiments of the present disclosure can also be implemented in cloud computing environments. In this description, “cloud computing” is defined as a subscription model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing subscription model can be composed of various characteristics such as, for example, on-demand self-service, broad network access, resource pooling, rapid elasticity, measured service, and so forth. A cloud-computing subscription model can also expose various service subscription models, such as, for example, Software as a Service (“SaaS”), a web service, Platform as a Service (“PaaS”), and Infrastructure as a Service (“IaaS”). A cloud-computing subscription model can also be deployed using different deployment subscription models such as private cloud, community cloud, public cloud, hybrid cloud, and so forth. In this description and in the claims, a “cloud-computing environment” is an environment in which cloud computing is employed.

FIG. 9 illustrates a block diagram of an example computing device 900 that may be configured to perform one or more of the processes described above. One will appreciate that one or more computing devices, such as the computing device 900 may represent the computing devices described above (e.g., the server(s) 102, the provider client devices 110a-110n, or the requestor client devices 116a-116n). In one or more embodiments, the computing device 900 may be a mobile device (e.g., a mobile telephone, a smartphone, a PDA, a tablet, a laptop, a camera, a tracker, a watch, a wearable device, etc.). In some embodiments, the computing device 900 may be a non-mobile device (e.g., a desktop computer or another type of client device). Further, the computing device 900 may be a server device that includes cloud-based processing and storage capabilities.

As shown in FIG. 9, the computing device 900 can include one or more processor(s) 902, memory 904, a storage device 906, input/output interfaces 908 (or “I/O interfaces 908”), and a communication interface 910, which may be communicatively coupled by way of a communication infrastructure (e.g., bus 912). While the computing device 900 is shown in FIG. 9, the components illustrated in FIG. 9 are not intended to be limiting. Additional or alternative components may be used in other embodiments. Furthermore, in certain embodiments, the computing device 900 includes fewer components than those shown in FIG. 9. Components of the computing device 900 shown in FIG. 9 will now be described in additional detail.

In particular embodiments, the processor(s) 902 includes hardware for executing instructions, such as those making up a computer program. As an example, and not by way of limitation, to execute instructions, the processor(s) 902 may retrieve (or fetch) the instructions from an internal register, an internal cache, memory 904, or a storage device 906 and decode and execute them.

The computing device 900 includes the memory 904, which is coupled to the processor(s) 902. The memory 904 may be used for storing data, metadata, and programs for execution by the processor(s). The memory 904 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 904 may be internal or distributed memory.

The computing device 900 includes the storage device 906 for storing data or instructions. As an example, and not by way of limitation, the storage device 906 can include a non-transitory storage medium described above. The storage device 906 may include a hard disk drive (“HDD”), flash memory, a Universal Serial Bus (“USB”) drive or a combination these or other storage devices.

As shown, the computing device 900 includes one or more I/O interfaces 908, which are provided to allow a user to provide input to (such as user strokes), receive output from, and otherwise transfer data to and from the computing device 900. These I/O interfaces 908 may include a mouse, keypad or a keyboard, a touch screen, camera, optical scanner, network interface, modem, other known I/O devices or a combination of such I/O interfaces 908. The touch screen may be activated with a stylus or a finger.

The I/O interfaces 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 908 are configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 provides one or more interfaces for communication (such as, for example, packet-based communication) between the computing device and one or more other computing devices or one or more networks. As an example, and not by way of limitation, communication interface 910 may include a network interface controller (“NIC”) or network adapter for communicating with an Ethernet or other wire-based network or a wireless NIC (“WNIC”) or wireless adapter for communicating with a wireless network, such as a WI-FI. The computing device 900 can further include the bus 912. The bus 912 can include hardware, software, or both that connects components of computing device 900 to each other.

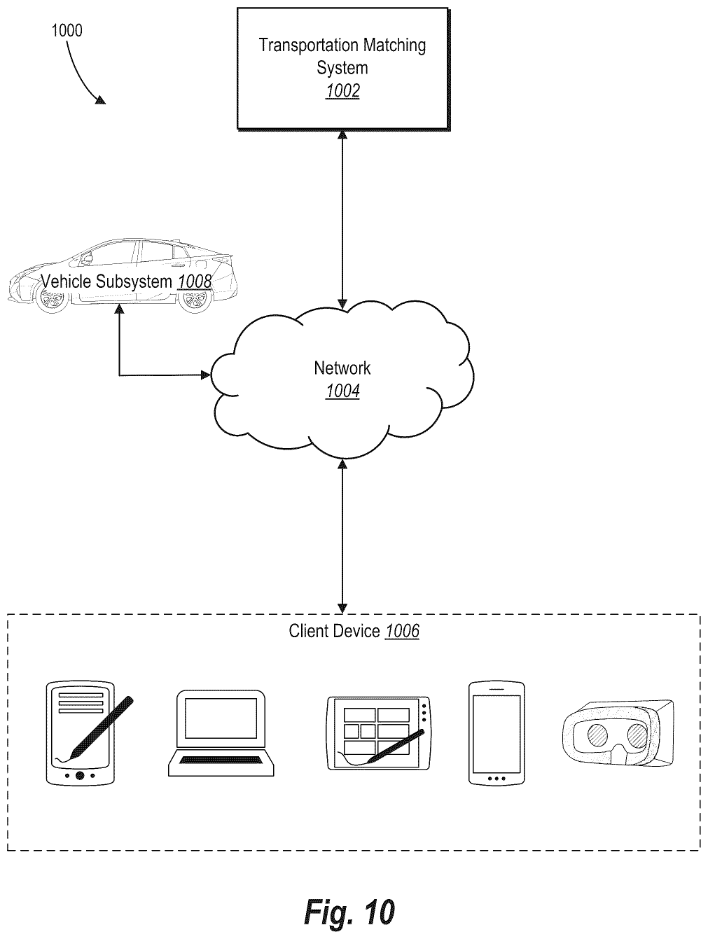

FIG. 10 illustrates an example network environment 1000 of a transportation matching system (e.g., the transportation matching system 104). The network environment 1000 includes a client device 1006, a transportation matching system 1002, and a vehicle subsystem 1008 connected to each other by a network 1004. Although FIG. 10 illustrates a particular arrangement of the client device 1006, the transportation matching system 1002, the vehicle subsystem 1008, and the network 1004, this disclosure contemplates any suitable arrangement of the client device 1006, the transportation matching system 1002, the vehicle subsystem 1008, and the network 1004. As an example, and not by way of limitation, two or more of the client device 1006, the transportation matching system 1002, and the vehicle subsystem 1008 communicate directly, bypassing the network 1004. As another example, two or more of the client device 1006, the transportation matching system 1002, and the vehicle subsystem 1008 may be physically or logically co-located with each other in whole or in part. Moreover, although FIG. 10 illustrates a particular number of the client devices 1006, the transportation matching systems 1002, the vehicle subsystems 1008, and the networks 1004, this disclosure contemplates any suitable number of the client devices 1006, the transportation matching systems 1002, the vehicle subsystems 1008, and the networks 1004. As an example, and not by way of limitation, the network environment 1000 may include multiple client devices 1006, multiple transportation matching systems 1002, multiple vehicle subsystems 1008, and multiple networks 1004.

This disclosure contemplates any suitable network 1004. As an example, and not by way of limitation, one or more portions of the network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. The network 1004 may include one or more networks 1004.

Links may connect the client device 1006, the transportation matching system 1002, and the vehicle subsystem 1008 to the network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout the network environment 1000. One or more first links may differ in one or more respects from one or more second links.

In particular embodiments, the client device 1006 may be an electronic device including hardware, software, or embedded logic components or a combination of two or more such components and capable of carrying out the appropriate functionalities implemented or supported by the client device 1006. As an example, and not by way of limitation, a client device 1006 may include any of the computing devices discussed above in relation to FIG. 10. A client device 1006 may enable a network user at the client device 1006 to access a network. A client device 1006 may enable its user to communicate with other users at other client devices 1006.

In particular embodiments, the client device 1006 may include a transportation service application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1006 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to client device 1006 one or more Hyper Text Markup Language (“HTML”) files responsive to the HTTP request. The client device 1006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the transportation matching system 1002 may be a network-addressable computing system that can host a ride share transportation network. The transportation matching system 1002 may generate, store, receive, and send data, such as, for example, user-profile data, concept-profile data, text data, ride request data, GPS location data, provider data, requester data, vehicle data, or other suitable data related to the ride share transportation network. This may include authenticating the identity of providers and/or vehicles who are authorized to provide ride services through the transportation matching system 1002. In addition, the transportation service system may manage identities of service requestors such as users/requesters. In particular, the transportation service system may maintain requester data such as driving/riding histories, personal data, or other user data in addition to navigation and/or traffic management services or other location services (e.g., GPS services).

In particular embodiments, the transportation matching system 1002 may manage ride matching services to connect a user/requester with a vehicle and/or provider. By managing the ride matching services, the transportation matching system 1002 can manage the distribution and allocation of vehicle subsystem resources and user resources such as GPS location and availability indicators, as described herein.

The transportation matching system 1002 may be accessed by the other components of the network environment 1000 either directly or via network 1004. In particular embodiments, the transportation matching system 1002 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 1002 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable the client device 1006 or the transportation matching system 1002 to manage, retrieve, modify, add, or delete, the information stored in data storage.

In particular embodiments, the transportation matching system 1002 may provide users with the ability to take actions on various types of items or objects, supported by the transportation matching system 1002. As an example, and not by way of limitation, the items and objects may include ride share networks to which users of the transportation matching system 1002 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 1002 or by an external system of a third-party system, which is separate from the transportation matching system 1002 and coupled to the transportation matching system 1002 via the network 1004.

In particular embodiments, the transportation matching system 1002 may be capable of linking a variety of entities. As an example, and not by way of limitation, the transportation matching system 1002 may enable users to interact with each other or other entities, or to allow users to interact with these entities through an application programming interfaces (“API”) or other communication channels.

In particular embodiments, the transportation matching system 1002 may include a variety of servers, sub-systems, programs, modules, logs, and data stores. In particular embodiments, the transportation matching system 1002 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The transportation matching system 1002 may also include suitable components such as network interfaces, security mechanisms, load balancers, failover servers, management-and-network-operations consoles, other suitable components, or any suitable combination thereof. In particular embodiments, the transportation matching system 1002 may include one or more user-profile stores for storing user profiles. A user profile may include, for example, biographic information, demographic information, behavioral information, social information, or other types of descriptive information, such as work experience, educational history, hobbies or preferences, interests, affinities, or location.

The web server may include a mail server or other messaging functionality for receiving and routing messages between the transportation matching system 1002 and one or more client devices 1006. An action logger may be used to receive communications from a web server about a user's actions on or off the transportation matching system 1002. In conjunction with the action log, a third-party-content-object log may be maintained of user exposures to third-party-content objects. A notification controller may provide information regarding content objects to the client device 1006. Information may be pushed to the client device 1006 as notifications, or information may be pulled from the client device 1006 responsive to a request received from the client device 1006. Authorization servers may be used to enforce one or more privacy settings of the users of the transportation matching system 1002. A privacy setting of a user determines how particular information associated with a user can be shared. The authorization server may allow users to opt in to or opt out of having their actions logged by the transportation matching system 1002 or shared with other systems, such as, for example, by setting appropriate privacy settings. Third-party-content-object stores may be used to store content objects received from third parties. Location stores may be used for storing location information received from the client devices 1006 associated with users.

In addition, the vehicle subsystem 1008 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 1008 can include an autonomous vehicle—i.e., a vehicle that does not require a human operator. In these embodiments, the vehicle subsystem 1008 can perform maneuvers, communicate, and otherwise function without the aid of a human provider, in accordance with available technology.

In particular embodiments, the vehicle subsystem 1008 may include one or more sensors incorporated therein or associated thereto. For example, sensor(s) can be mounted on the top of the vehicle subsystem 1008 or else can be located within the interior of the vehicle subsystem 1008. In certain embodiments, the sensor(s) can be located in multiple areas at once—i.e., split up throughout the vehicle subsystem 1008 so that different components of the sensor(s) can be placed in different locations in accordance with optimal operation of the sensor(s). In these embodiments, the sensor(s) can include a LIDAR sensor and an inertial measurement unit (“IMU”) including one or more accelerometers, one or more gyroscopes, and one or more magnetometers. The sensor suite can additionally or alternatively include a wireless IMU (“WIMU”), one or more cameras, one or more microphones, or other sensors or data input devices capable of receiving and/or recording information relating to navigating a route to pick up, transport, and/or drop off a requester.

In particular embodiments, the vehicle subsystem 1008 may include a communication device capable of communicating with the client device 1006 and/or the transportation matching system 1002. For example, the vehicle subsystem 1008 can include an on-board computing device communicatively linked to the network 1004 to transmit and receive data such as GPS location information, sensor-related information, requester location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

1-20. (canceled)

21. A method comprising:
monitoring, via one or more server devices, global positioning information of a plurality of provider client devices to determine provider client device locations;
providing, for display via a graphical user interface of a provider client device of the plurality of provider client devices, a dynamic map comprising a current provider device location based on the global positioning information, an inner geocoded area zone, an outer geocoded area zone, an accumulating inducement value, and instructions corresponding to the accumulating inducement value, wherein the one or more server devices provides the graphical user interface by:
determining a provider-target constraint comprising the accumulating inducement value;
utilizing the global positioning information to determine an allocation of the plurality of provider client devices across geocoded areas; and
generating, utilizing a provider-allocation model subject to the provider-target constraint over a time period and based on the allocation of the plurality of provider client devices, a final adjusted allocation for geocoded areas comprising the inner geocoded area zone and the outer geocoded area zone, wherein the final adjusted allocation conforms to the provider-target constraint; and
in response to detecting, based on updated global positioning information, that the provider client device has crossed a geo-boundary of the inner geocoded area zone or the outer geocoded area zone, providing, for display via the graphical user interface of the provider client device, a modified dynamic map comprising an updated provider device location, the inner geocoded area zone, the outer geocoded area zone, a modified accumulating inducement value, and modified instructions corresponding to the modified accumulating inducement value.

22. The method of claim 21, comprising:
in response to generating the final adjusted allocation for the geocoded areas, providing, for display via the graphical user interface of the provider client device of the plurality of provider client devices, a push notification from the one or more server devices; and
in response to a selection of the push notification from the provider client device, providing, for display via the graphical user interface of the provider client device, the dynamic map.

23. The method of claim 21, wherein detecting that the provider client device has crossed the geo-boundary of the outer geocoded area zone further comprises:
providing, for display via the graphical user interface of the provider client device, the modified instructions comprising instructions to accept a request to obtain the modified accumulating inducement value; and
in response to detecting, via the one or more server devices, that the provider client device has accepted a transportation request from a requestor device, determining that the modified accumulating inducement value is obtained by the provider client device.

24. The method of claim 23, further comprising:
in response to detecting that the provider client device has crossed the geo-boundary of the inner geocoded area zone, providing, for display via the graphical user interface of the provider client device, an additional modified accumulating inducement value greater than the modified accumulating inducement value; and
in response to detecting, via the one or more server devices, that the provider client device has accepted an additional transportation request from an additional requestor device, determining that the additional modified accumulating inducement value is obtained by the provider client device.

25. The method of claim 21, further comprising:
monitoring, via the one or more server devices, time spent by the provider client device in the inner geocoded area zone;
based on the time spent in the inner geocoded area zone, generating the modified accumulating inducement value;
in response to additional monitoring, via the one or more server devices, determining that an additional time spent by the provider client device in the inner geocoded area zone; and
based on the additional time spent in the inner geocoded area zone, generating an additional modified accumulating inducement value that is greater than the modified accumulating inducement value.

26. The method of claim 21, wherein the one or more server devices provides the graphical user interface by:
generating, utilizing an objective function of a transportation-rate model, a transportation-value metric corresponding to the geocoded areas for the time period based on a number of projected transportation requests across the geocoded areas and a neighborhood constraint,
wherein the transportation-value metric comprises a measurement of efficiency for the geocoded areas that indicates at least one of a quantity of transportation requests, a conversion metric, a profit metric, or a revenue metric,
wherein the neighborhood constraint comprises additional geocoded areas neighboring the geocoded areas; and
generating, utilizing the provider-allocation model subject to the provider-target constraint over the time period and based on the allocation of the plurality of provider client devices and the transportation-value metric, the final adjusted allocation for the geocoded areas.

27. The method of claim 26, further comprising generating, utilizing the objective function of the transportation-rate model, an updated transportation-value metric based on the final adjusted allocation for the geocoded areas.

28. A system comprising:
at least one processor; and
at least one non-transitory computer readable storage medium storing instructions that, when executed by the at least one processor, cause the system to:
monitor, via one or more server devices, global positioning information of a plurality of provider client devices to determine provider client device locations;
provide, for display via a graphical user interface of a provider client device of the plurality of provider client devices, a dynamic map comprising a current provider device location based on the global positioning information, an inner geocoded area zone, an outer geocoded area zone, an accumulating inducement value, and instructions corresponding to the accumulating inducement value, wherein the one or more server devices provides the graphical user interface by:
determining a provider-target constraint comprising the accumulating inducement value;
utilizing the global positioning information to determine an allocation of the plurality of provider client devices across geocoded areas; and
generating, utilizing a provider-allocation model subject to the provider-target constraint over a time period and based on the allocation of the plurality of provider client devices, a final adjusted allocation for geocoded areas comprising the inner geocoded area zone and the outer geocoded area zone, wherein the final adjusted allocation conforms to the provider-target constraint; and
in response to detecting, based on updated global positioning information, that the provider client device has crossed a geo-boundary of the inner geocoded area zone or the outer geocoded area zone, provide, for display via the graphical user interface of the provider client device, a modified dynamic map comprising an updated provider device location, the inner geocoded area zone, the outer geocoded area zone, a modified accumulating inducement value, and modified instructions corresponding to the modified accumulating inducement value.

29. The system of claim 28, further comprising instructions that, when executed by the at least one processor, cause the system to:
in response to generating the final adjusted allocation for the geocoded areas, provide, for display via the graphical user interface of the provider client device of the plurality of provider client devices, a push notification from the one or more server devices; and
in response to a selection of the push notification from the provider client device, provide, for display via the graphical user interface of the provider client device, the dynamic map.

30. The system of claim 28, further comprising instructions that, when executed by the at least one processor, cause the system to:
provide, for display via the graphical user interface of the provider client device, the modified instructions comprising instructions to accept a request to obtain the modified accumulating inducement value; and
in response to detecting, via the one or more server devices, that the provider client device has accepted a transportation request from a requestor device, determine that the modified accumulating inducement value is obtained by the provider client device.

31. The system of claim 30, further comprising instructions that, when executed by the at least one processor, cause the system to:
in response to detecting that the provider client device has crossed the geo-boundary of the inner geocoded area zone, provide, for display via the graphical user interface of the provider client device, an additional modified accumulating inducement value greater than the modified accumulating inducement value; and
in response to detecting, via the one or more server devices, that the provider client device has accepted an additional transportation request from an additional requestor device, determine that the additional modified accumulating inducement value is obtained by the provider client device.

32. The system of claim 28, further comprising instructions that, when executed by the at least one processor, cause the system to:
monitor, via the one or more server devices, time spent by the provider client device in the inner geocoded area zone;
based on the time spent in the inner geocoded area zone, generate the modified accumulating inducement value;
in response to additional monitoring, via the one or more server devices, determine that an additional time spent by the provider client device in the inner geocoded area zone; and
based on the additional time spent in the inner geocoded area zone, generate an additional modified accumulating inducement value that is greater than the modified accumulating inducement value.

33. The system of claim 28, further comprising instructions that, when executed by the at least one processor, cause the system to provide the graphical user interface by:
generating, utilizing an objective function of a transportation-rate model, a transportation-value metric corresponding to the geocoded areas for the time period based on a number of projected transportation requests across the geocoded areas and a neighborhood constraint,
wherein the transportation-value metric comprises a measurement of efficiency for the geocoded areas that indicates at least one of a quantity of transportation requests, a conversion metric, a profit metric, or a revenue metric,
wherein the neighborhood constraint comprises additional geocoded areas neighboring the geocoded areas; and
generating, utilizing the provider-allocation model subject to the provider-target constraint over the time period and based on the allocation of the plurality of provider client devices and the transportation-value metric, the final adjusted allocation for the geocoded areas.

34. A non-transitory computer readable medium storing instructions thereon that, when executed by at least one processor, cause a computer system to:
monitor, via one or more server devices, global positioning information of a plurality of provider client devices to determine provider client device locations;
provide, for display via a graphical user interface of a provider client device of the plurality of provider client devices, a dynamic map comprising a current provider device location based on the global positioning information, an inner geocoded area zone, an outer geocoded area zone, an accumulating inducement value, and instructions corresponding to the accumulating inducement value, wherein the one or more server devices provides the graphical user interface by:
determining a provider-target constraint comprising the accumulating inducement value;
utilizing the global positioning information to determine an allocation of the plurality of provider client devices across geocoded areas; and
generating, utilizing a provider-allocation model subject to the provider-target constraint over a time period and based on the allocation of the plurality of provider client devices, a final adjusted allocation for geocoded areas comprising the inner geocoded area zone and the outer geocoded area zone, wherein the final adjusted allocation conforms to the provider-target constraint; and
in response to detecting, based on updated global positioning information, that the provider client device has crossed a geo-boundary of the inner geocoded area zone or the outer geocoded area zone, provide, for display via the graphical user interface of the provider client device, a modified dynamic map comprising an updated provider device location, the inner geocoded area zone, the outer geocoded area zone, a modified accumulating inducement value, and modified instructions corresponding to the modified accumulating inducement value.

35. The non-transitory computer readable medium of claim 34, further comprising instructions that, when executed by the at least one processor, cause the computer system to:
in response to generating the final adjusted allocation for the geocoded areas, provide, for display via the graphical user interface of the provider client device of the plurality of provider client devices, a push notification from the one or more server devices; and
in response to a selection of the push notification from the provider client device, provide, for display via the graphical user interface of the provider client device, the dynamic map.

36. The non-transitory computer readable medium of claim 34, further comprising instructions that, when executed by the at least one processor, cause the computer system to:
provide, for display via the graphical user interface of the provider client device, the modified instructions comprising instructions to accept a request to obtain the modified accumulating inducement value; and
in response to detecting, via the one or more server devices, that the provider client device has accepted a transportation request from a requestor device, determine that the modified accumulating inducement value is obtained by the provider client device.

37. The non-transitory computer readable medium of claim 36, further comprising instructions that, when executed by the at least one processor, cause the computer system to:
in response to detecting that the provider client device has crossed the geo-boundary of the inner geocoded area zone, provide, for display via the graphical user interface of the provider client device, an additional modified accumulating inducement value greater than the modified accumulating inducement value; and
in response to detecting, via the one or more server devices, that the provider client device has accepted an additional transportation request from an additional requestor device, determine that the additional modified accumulating inducement value is obtained by the provider client device.

38. The non-transitory computer readable medium of claim 34, further comprising instructions that, when executed by the at least one processor, cause the computer system to:
monitor, via the one or more server devices, time spent by the provider client device in the inner geocoded area zone;
based on the time spent in the inner geocoded area zone, generate the modified accumulating inducement value;
in response to additional monitoring, via the one or more server devices, determine that an additional time spent by the provider client device in the inner geocoded area zone; and
based on the additional time spent in the inner geocoded area zone, generate an additional modified accumulating inducement value that is greater than the modified accumulating inducement value.

39. The non-transitory computer readable medium of claim 34, further comprising instructions that, when executed by the at least one processor, cause the computer system to provide the graphical user interface by:
generating, utilizing an objective function of a transportation-rate model, a transportation-value metric corresponding to the geocoded areas for the time period based on a number of projected transportation requests across the geocoded areas and a neighborhood constraint,
wherein the transportation-value metric comprises a measurement of efficiency for the geocoded areas that indicates at least one of a quantity of transportation requests, a conversion metric, a profit metric, or a revenue metric,
wherein the neighborhood constraint comprises additional geocoded areas neighboring the geocoded areas; and
generating, utilizing the provider-allocation model subject to the provider-target constraint over the time period and based on the allocation of the plurality of provider client devices and the transportation-value metric, the final adjusted allocation for the geocoded areas.

40. The non-transitory computer readable medium of claim 39, further comprising instructions that, when executed by the at least one processor, cause the computer system to generate, utilizing the objective function of the transportation-rate model, an updated transportation-value metric based on the final adjusted allocation for the geocoded areas.
